(19) United States
(12) Patent Application Publication
(10) Pub. No.: US 2017/0091550 A1
(43) Pub. Date: Mar. 30, 2017

(54) MULTISPECTRAL EYE ANALYSIS FOR IDENTITY AUTHENTICATION

(71) Applicant: QUALCOMM Incorporated, San Diego, CA (US)

(72) Inventors: Chen Feng, Markham (CA); Xiaopeng Zhang, Richmond Hill (CA); Shaojie Zhuo, Markham (CA); Liang Shen, Toronto (CA); Tao Sheng, Richmond Hill (CA); Alwyn Dos Remedios, Vaughan (CA)

(21) Appl. No.: 14/332,250

(22) Filed: Jul. 15, 2014

(51) Int. Cl. G06K 9/00; H04N 9/04; H04N 5/33; G06T 7/00; G06T 7/38; G06F 21/32; G06T 7/90; G06T 7/70; G06T 7/11; G06T 11/60; G06T 3/20

(52) U.S. Cl. CPC G06K 9/00617; G06T 11/60; H04N 9/04; H04N 5/332; G06K 9/00604; G06T 7/0012; G06T 3/20; G06F 21/32; G06T 7/90; G06T 7/70; G06T 7/11; G06T 7/38; G06T 2207/20021; G06T 2207/20221; G06T 2207/10024; G06T 2207/10048; G06T 2207/30041; G06T 2207/20056; H04N 5/2256

(57) ABSTRACT

Certain aspects relate to systems and techniques for generating high resolution iris templates and for detecting spoofs, enabling more reliable and secure iris authentication. Pairs of RGB and NIR images can be captured by the iris authentication system for use in iris authentication, for example using an NIR LED flash and a four-channel image sensor. Multiple images of the user's iris can be captured by the system in a relatively short period of time and can be fused together to generate a high resolution iris image that can contain more detail of the iris structure and unique pattern than each individual images. The “liveness” of the iris, referring to whether the iris is a real human iris or an iris imitation, can be assessed via a liveness ratio based on comparison of known iris and sclera reflectance properties at various wavelengths to determined sensor responses at those same wavelengths.

### CROSS-REFERENCE TO RELATED APPLICATIONS

The present application is related to U.S. patent application Ser. No. ______, filed on Jul. 15, 2014, entitled “MULTISPECTRAL EYE ANALYSIS FOR IDENTITY AUTHENTICATION” and U.S. patent application Ser. No. ______, filed on Jul. 15, 2014, entitled “MULTISPECTRAL EYE ANALYSIS FOR IDENTITY AUTHENTICATION,” the contents of which are substantially identical and hereby incorporated by reference herein.

### TECHNICAL FIELD

The systems and methods disclosed herein are directed to iris matching for identity authentication, and, more particularly, to improving iris image capture and authentication reliability.

### BACKGROUND

Personal information security on technology such as mobile devices is critically important. Passcodes, facial recognition, and fingerprint scanning are several major approaches to protect private or sensitive information on mobile devices. However, these existing approaches suffer from several problems. Passcodes, either in numerical or graphical format, are reliable but difficult to memorize and unnatural to use. People have to remember different passcodes that are used for different purposes, such as phone unlock or online purchasing, and such passcodes have to be entered multiple times a day. Facial imaging can be used to recognize a person, however it is not reliable for secure applications as face images are easy to acquire and replicate. Fingerprint scanning is easy to apply and very robust, however carries a high risk of spoofing as fingerprints are left on most objects touched by the mobile device user, including on the mobile device.

Iris recognition is a method of biometric authentication that uses pattern recognition techniques based on high-resolution images of the irises of a person's eyes. The irises are the circular structure in the eyes responsible for controlling the aperture of the pupil and exhibiting eye color, and exhibit a complex and very fine texture that, like fingerprints, is unique to each individual and remains remarkably stable over many decades. Even genetically identical individuals have different iris patterns, making the iris a good candidate for identity authentication. Iris recognition systems use camera technology to create images of the detail-rich, intricate structures of an iris. Mathematical representations of images of the iris may help generate a positive identification of an individual.

One drawback of iris identification systems is that dedicated iris scanners used to generate high resolution iris images can be expensive and not easily integrated into existing technology for security purposes. Many common cameras, for example conventional front-facing mobile image sensors, may not generate a high enough resolution image of an iris for accurate iris feature matching. Another drawback of iris identification is that iris identification systems can be easily fooled by an artificial copy of an iris image used in place of a live human iris or face. A variety of materials and methods, from the inexpensive to the very sophisticated, can be used to circumvent traditional iris identification systems. Called “spoofs,” these fake irises range from images of irises reproduced on paper, spheres, or other materials to high-resolution iris reproductions on contact lenses that can even be worn and used, undetected, in access control environments that have trained attendants.

### SUMMARY

The foregoing problems, among others, are addressed by the multispectral iris authentication systems and methods described herein for generating high resolution iris images and for detecting spoofs, enabling more reliable and secure authentication. The multispectral iris authentication systems and methods disclosed herein can be used to generate high resolution iris images, even using relatively low resolution image sensors, through a multi-frame iris fusion process. Accordingly, iris authentication can be performed using conventional camera systems, for example a webcam connected to a personal computer or in mobile devices such as smartphones, tablet computers, and the like. In addition, the multispectral iris authentication systems and methods disclosed herein can be used to perform a liveness detection process based on known reflectance properties of real iris and sclera (i.e., the white of the eye) to light at multiple wavelengths. Spoofs can be detected using the liveness detection process, making identity authentication more secure by rejecting authentication attempts using fake irises. The multispectral iris authentication techniques described herein can be performed, in some examples, entirely by a mobile device such as a smartphone, tablet computer, or other mobile personal computing device, for example allowing iris authentication to be used in a user's daily life in place of passcodes for protecting account access and sensitive information.

Accordingly, one aspect relates to a system for generating a fused iris image, the system comprising at least one image sensor configured to capture a plurality of image frames depicting an eye and iris of a user; a tracking module configured to detect a location of the eye and a location of the iris of the eye in an initial frame of the plurality of image frames, and track one or both of the location of the eye and the location of the iris in at least one subsequent frame of the plurality of image frames; and a multi-frame iris fusion module configured to select a base frame from the plurality of image frames based at least partly on a quality measurement metric, segment the at least one subsequent frame into a segmented iris by isolating pixels depicting the iris from pixels not depicting the iris, divide the segmented iris into a plurality of local patches, align the plurality of local patches with corresponding locations within the base frame, and selectively fuse at least some of the plurality of local patches with the base frame to generate a fused image including a greater level of detail of the iris than a level of detail of the iris in any of the plurality of image frames.

Another aspect relates to a method for generating a fused iris image, the method comprising receiving a plurality of image frames depicting an eye and iris of a user; detecting a location of the eye and a location of the iris of the eye in an initial frame of the plurality of image frames; tracking one or both of the location of the eye and the location of the iris in at least one subsequent frame of the plurality of image frames; selecting a base frame from the plurality of image frames based at least partly on a quality measurement metric; segmenting the at least one subsequent frame into a segmented iris by isolating pixels depicting the iris from pixels not depicting the iris; dividing the segmented iris into a plurality of local patches; aligning the plurality of local patches with corresponding locations within the base frame; and selectively fusing at least some of the plurality of local patches with the base frame to generate a fused image including a greater level of detail of the iris than a level of detail of the iris in any of the plurality of image frames.

Another aspect relates to a non-transitory computer-readable medium storing instructions that, when executed, configure at least one processor to perform operations comprising receiving a plurality of image frames depicting an eye and iris of a user; tracking one or both of the location of the eye and the location of the iris in the plurality of image frames; selecting a base frame from the plurality of image frames based at least partly on a quality measurement metric; generating a plurality of segmented irises by, for each the plurality of image frames, isolating pixels depicting the iris from pixels not depicting the iris; dividing a representation of each of the plurality of segmented irises into a plurality of local patches; aligning the plurality of local patches with corresponding locations within a representation of the base frame; and selectively fusing at least some of the plurality of local patches with the representation of the base frame to generate a fused image including a greater level of detail of the iris than in any of the plurality of image frames.

Another aspect relates to a multi-frame iris fusion apparatus comprising means for receiving a plurality of image frames depicting an eye and iris of a user; means for selecting a base frame from the plurality of image frames based at least partly on a quality measurement metric; means for generating a plurality of segmented irises by, for each the plurality of image frames, isolating pixels depicting the iris from pixels not depicting the iris; means for dividing a representation of each of the plurality of segmented irises into a plurality of local patches; means for aligning the plurality of local patches with corresponding locations within a representation of the base frame; and means for selectively fusing at least some of the plurality of local patches with the representation of the base frame to generate a fused image including a greater level of detail of the iris than in any of the plurality of image frames.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIGS. 1A and 1B illustrate examples of a multispectral iris authentication user interface, according to various implementations.

FIG. 2 illustrates example stages of an embodiment of a multispectral iris authentication technique.

FIG. 3 is a flowchart illustrating an embodiment of an identity authentication process implementing multispectral iris authentication.

FIG. 4A is a flowchart illustrating an embodiment of a multispectral iris image capture process.

FIG. 4B is a flowchart illustrating an embodiment of a multispectral multi-frame iris image capture and eye tracking process.

FIG. 5 illustrates a high-level graphical overview of a multi-frame fusion process.

FIG. 6 is a flowchart illustrating an embodiment of a multi-frame fusion process.

FIG. 7 illustrates a graphical representation of iris and sclera portions of an eye that can be used for liveness detection.

FIG. 8A is a graph illustrating the reflectance spectra of a live human iris.

FIG. 8B is a graph illustrating the reflectance spectra of a live human sclera.

FIG. 8C illustrates experimental results from using the multispectral iris authentication techniques described herein.

FIG. 9 is a flowchart illustrating an embodiment of a liveness detection process.

FIG. 10 illustrates a high-level schematic block diagram of an embodiment of an image capture device having multispectral iris authentication capabilities.

### DETAILED DESCRIPTION

### Introduction

Embodiments of the disclosure relate to systems and techniques for multispectral iris authentication including generating high resolution iris images and detecting spoofs. Pairs of visible light (RGB) and near-infrared (NIR) images can be captured by the iris authentication system for use in iris authentication, for example using an NIR LED flash to provide consistent NIR lighting. Continuous tracking can be provided by the multispectral iris authentication system to track the user's iris region in a number of images even when the relative distance and/or angle between the user's iris and the system camera change. Multiple images of the user's iris can be captured by the system in a relatively short period of time, for example as video frames at a rate around 30 frames per second (fps). The system can fuse these multiple images together to generate a high resolution iris image that can contain more detail of the iris structure and unique pattern than each individual images. The “liveness” of the iris, referring to whether the iris is a real human iris or an iris imitation, can be assessed by the system based on comparing the reflectance of different spectrums of light in the captured RGB and NIR images to known multispectral reflectance properties of the different portions of the human eye. For live irises, the system can compare the captured image to a stored template of an authorized user's iris to perform identity authentication.

For example, in some embodiments the multispectral iris authentication system can capture multiple frames of a user's eye, track the eye and iris location across the multiple frames, and can selectively fuse the frames together to generate a fused iris image. Tracking the eye and iris location across the multiple frames can involve determining pixels in each frame that correspond to the eye and iris. The iris authentication system can separate the pixels corresponding to the iris in each frame into a number of smaller local patches, align the patches, and fuse the details of the patches into a single fused image. Accordingly, even relatively low-resolution image sensors can be used to generate enough iris detail for accurate iris authentication.

In some embodiments, the multispectral iris authentication system can capture image data of a user's eye at multiple wavelengths to assist in determining whether the iris is real or an imitation. For example, in one embodiment, the system may include a visible light imaging sensor (“RGB sensor”) and an infrared or near-infrared light imaging sensor (“NIR sensor”). In some embodiments, a single image sensor can be used to capture light at visible and/or NIR wavelengths. An RGB image and an NIR image can be captured of the user's eye at different exposures in some examples. The reflectance of light off of the iris and sclera regions of the eye can be measured at visible and NIR wavelengths and used to determine whether the iris in the image is real or a spoof. If the iris is real, then the system can perform iris feature matching to determine whether the iris matches a user iris stored in a template. A real iris that matches a stored template iris can result in user authentication.

Although discussed herein primarily in the context of identity authentication using a portable personal device such as a smartphone, the multispectral iris authentication techniques described herein can be used in a wide range of security contexts, including mobile (portable systems/devices) and stationary implementations. The multispectral iris authentication techniques described herein can be used, in some examples, in larger computing devices or incorporated into computing systems built in to vehicles. As another example, stationary computing devices such as automated bank teller machines or secured entries to limited-access locations may implement the multispectral iris authentication techniques described herein.

As used herein, near-infrared (NIR) refers to the region of the electromagnetic spectrum ranging from wavelengths of between approximately 750 nm and 800 nm to approximately 2500 nm. The red, green, and blue channels of RGB image data as used herein refer to wavelength ranges roughly following the color receptors in the human eye. As a person of ordinary skill in the art will appreciate, exact beginning and ending wavelengths (or portions of the electromagnetic spectrum) that define colors of light (for example, red, green, and blue light) or NIR or infra-red (IR) electromagnetic radiation are not typically defined to be at single wavelength. Electromagnetic radiation ranging from wavelengths around 760 nm or 750 nm to wavelengths around 400 nm or 380 nm are typically considered the “visible” spectrum, that is, the portion of the spectrum recognizable by the structures of the human eye. Red light typically is considered to have a wavelength around 650 nm, or between approximately 760 nm to approximately 590 nm. However, some image sensors that can be used to capture the iris image data used in the multispectral imaging techniques described herein may be used in conjunction with a color filter array (CFA) or color filter mosaic (CFM). Such color filters split all incoming light in the visible range into red, green, and blue categories to direct the split light to dedicated red, green, or blue photodiode receptors on the image sensor, and can also separate NIR light and direct the NIR light to dedicated photodiode receptors on the image sensor. As such, the wavelength ranges of the color filter can determine the wavelength ranges represented by each color channel in the captured image. Accordingly, a red channel of an image may correspond to the red wavelength region of the color filter and can include some yellow and orange light, ranging from approximately 570 nm to approximately 760 nm in various embodiments. A green channel of an image may correspond to a green wavelength region of a color filter and can include some yellow light, ranging from approximately 570 nm to approximately 480 nm in various embodiments. A blue channel of an image may correspond to a blue wavelength region of a color filter and can include some violet light, ranging from approximately 490 nm to approximately 400 nm in various embodiments.

Various examples will now be described for the purpose of explaining, and not limiting, the disclosed aspects.

### Overview of Example User Interface

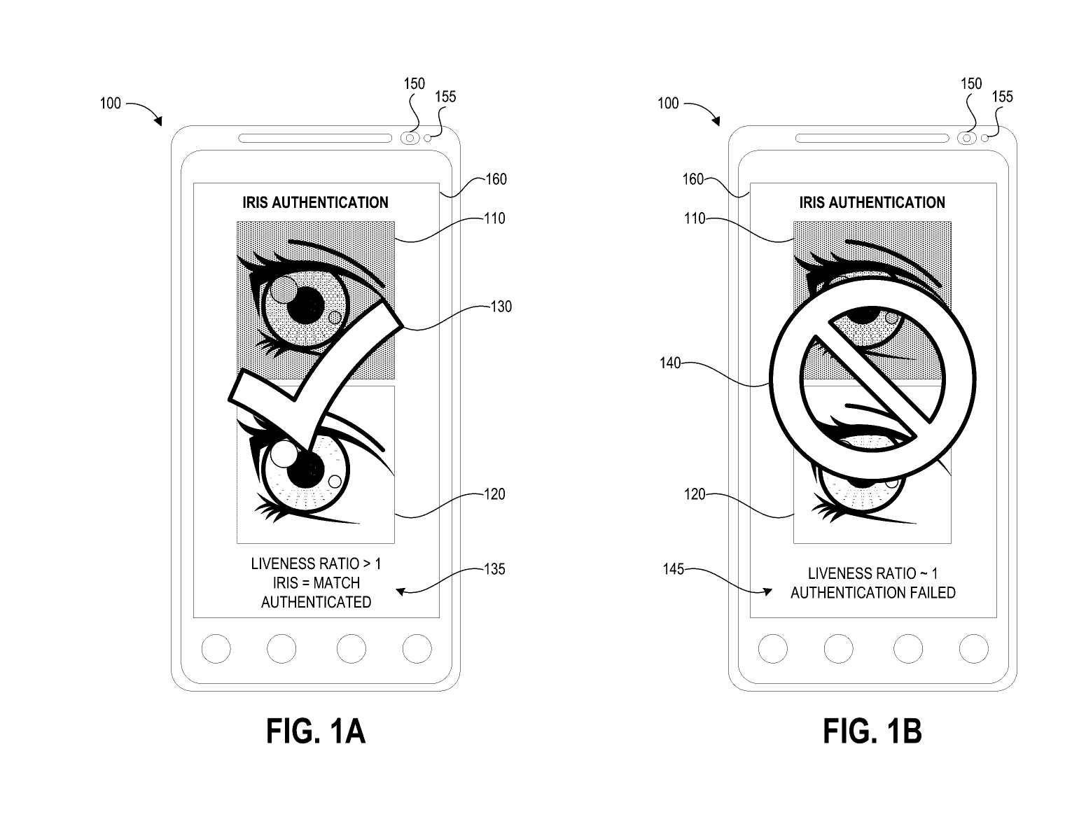

FIGS. 1A and 1B illustrate examples of a multispectral iris authentication user interface, according to various implementations. In the illustrated example, the multispectral iris authentication is implemented using a smartphone 100. However, in other examples, the multispectral iris authentication can be implemented using other portable personal computing devices such as tablet computers, laptops, digital cameras, gaming consoles, personal digital assistants, media playback devices, electronic book readers, augmented reality glasses or devices, and wearable portable computing devices, to name a few. Further, the multispectral iris authentication can be implemented using larger computing devices such as personal computers, televisions, automated teller machines, building security systems, vehicle security systems, stationary data terminals, and the like.

Smartphone 100 includes a front-facing camera 150 with a flash LED 155 and a display 160. The camera 150 can be capable of capturing image data in the visible (RGB) and IR or NIR spectrums. For example, in some embodiments the camera 150 can include a single RGB-IR sensor, such as the 4 MP OV4682 RGB-IR image sensor available from OmniVision in some embodiments. The camera 150 sensor may include a RGBN (red, green, blue, and near-infrared) color filter array (CFA) layer positioned between the RGB-IR sensor and incoming light from a target image scene, the color filter array layer for arranging the visible and NIR light on a square grid of photodiodes in the RGB-IR sensor. A dual band pass filter can be positioned between the RGB-IR sensor and the CFA, the dual band pass filter having a first band allowing visible light to pass through the filter and a second band allowing NIR light to pass through the filter. The second band can allow passage of a narrow range of NIR wavelengths matched to the emission wavelengths of an NIR LED in some embodiments, as discussed in more detail below. Accordingly, a single sensor can be used to capture image data in both visible and NIR wavelengths, for example generating an RGB image and an NIR image. It should be appreciated that the order of the dual band pass filter and the CFA can be reversed in some embodiments. In some embodiments, the camera 150 can include separate RGB and NIR sensors, and is configured to capture and process the images from each of the sensors in a similar manner as a single sensor embodiment. In other embodiments, one or more of each of an RGB and/or an NIR sensor may be included to capture images of an iris from different viewpoints.

The LED flash 155 can include a NIR LED (near infrared light-emitting diode) in some embodiments for illuminating a user's eye in the target image scene with NIR light, providing robustness for the multispectral iris authentication technique in a range of lighting conditions. For example, use of NIR light to capture the detail of the random pattern of the iris can facilitate repeatable acquisition of the details of a user's iris pattern without any irregularity due to the varying color temperatures of artificial ambient light sources. LED flash 155 can be configured to output light at wavelengths in the NIR spectrum between approximately from about 750 nm to 2500 nm, or can be configured to output light at a specific NIR wavelength, for example corresponding to the second band in the dual band pass filter. Such an NIR LED can be activated in some embodiments for each iris authentication image to provide NIR lighting to the user. In other embodiments, the NIR LED can be activated if the user device 100 determines that insufficient natural NIR lighting is present in the image scene. Because NIR lighting is not visible to the human eye, use of the NIR flash for iris authentication will not be obtrusive to the user.

The display 160 can be used to present a preview of iris images captured using the front-facing camera 150 in some embodiments in some embodiments before presenting the illustrated iris authentication interface. For example, a user can align the field of view of the camera 150 with the user's eye using a preview image presented on display 160. Accordingly, the multispectral iris authentication can be capable of accurate iris authentication at hand-held working distances, for instance between approximately 15 cm and approximately 30 cm.

In some embodiments such as the illustrated iris authentication interface, the display 160 can be configured for depicting an authentication interface including a visible representation of an NIR image 110 of the user's iris together with an RGB image of the user's iris. With reference now to FIG. 1A, an example user interface depicting a successful iris authentication is displayed. The user interface includes the NIR and RGB iris images 110, 120, graphical pass indication 130, and explanatory text 135 regarding the liveness score and iris matching can be displayed. Turning to FIG. 1B, an example user interface depicting an unsuccessful iris authentication is displayed. The user interface includes the NIR and RGB iris images 110, 120, graphical fail indication 140, and explanatory text 145 regarding the liveness score and iris matching can be displayed. In other examples of an iris authentication interface, only a pass or fail output may be displayed. Various graphical representations of the multispectral iris authentication techniques disclosed herein are possible, and the illustrated user interfaces are provided to explain and not limit the disclosure.

### Overview of Example Multispectral Iris Authentication Process

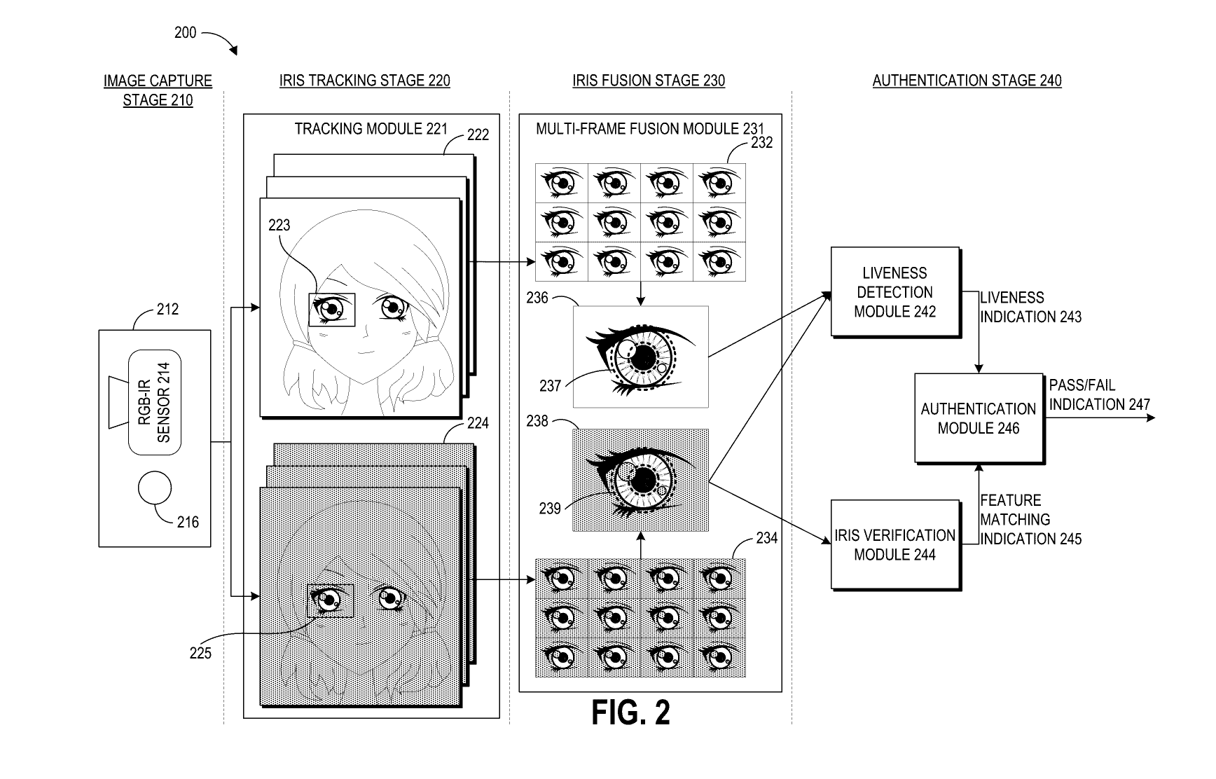

FIG. 2 illustrates example stages of an embodiment of a multispectral iris authentication system 200 including an image capture stage 210 performed by a camera 212, a tracking stage 220 performed by a tracking module 221, an iris fusion stage 230 performed by a multi-frame iris fusion module 231, and an authentication stage 240 performed by one or more of a liveness detection module 242, iris verification module 244, and authentication module 246.

As illustrated, the image capture stage 210 can be accomplished by a camera 212 including an RGB-IR or RGBN image sensor 214 and an NIR flash LED 216. In other embodiments separate NIR and RGB sensors can be used to capture the images for iris authentication. Camera 212 can capture pairs of RGB and NIR images of a user's eye substantially simultaneously. In some embodiments, camera 212 can capture a number of image frames for each of RGB and NIR image data, such as in a video recording mode. Although separate RGB and NIR images are depicted, this is for purposes of illustration and in some embodiments a single four-channel RGBN image can be captured, and information from the four channels can be selectively processed or analyzed as described with respect to the illustrated RGB and NIR images.

In the iris tracking stage 220, a tracking module 221 can receive a number of RGB frames 222 and a number of NIR frames 224 from the camera 212. The tracking module 221 can determine the eye and iris location in an initial RGB and NIR image pair and can track the eye and iris locations in subsequent image frames even if the relative distance and/or angle between the user iris and the camera 212 changes. For each RGB and NIR frame, the tracking module 221 can determine pixels in each of the captured RGB and NIR images corresponding to a rectangular or other shaped region around the eye 223, 225 in some embodiments. Additionally or alternatively, the tracking module 221 can identify pixels along a boundary between the iris and the surrounding sclera, determine an ellipse defined by the identified iris-sclera boundary pixels, determine a distance-to-pixel ratio based on a pixel length of a long axis of such an ellipse compared to a known or presumed diameter of the iris, locate the iris in a three-axis coordinate system, determine an optical axis vector of the eye in the three-axis coordinate system, and calculate a center of the eyeball based on the optical axis vector and a known or presumed eyeball radius. Details of a tracking technique that can be used to track an iris are disclosed in U.S. Patent Pub. No. 2013/0272570, filed Mar. 12, 2013, titled “Robust and efficient learning object tracker,” the entire contents of which are hereby incorporated by reference. In some embodiments, data representing eye and iris locations can be stored in a learning data repository to assist with tracking in subsequent frames. In some embodiments, a single image captured by the camera 212 may have sufficient resolution for multispectral iris authentication, and accordingly the tracking stage 220 can perform eye and iris location identification on only a single RGB image and a single NIR image.

In the iris fusion stage 230, a multi-frame iris fusion module 231 can generate a fused RGB iris polar image 236 based on a number of RGB iris image frames 232 and generate a fused NIR iris polar image 238 based on a number of NIR iris image frames 234. The multi-frame iris fusion module 231 can receive the iris image frames 232, 234 based on the tracked iris locations in the number of RGB frames 222 and the number of NIR frames 224. In some embodiments, a sharpest frame of each of the RGB and NIR iris image frames 232, 234 can be selected as a base frame. Each of the iris image frames 232, 234 can be segmented to isolate the pixels depicting the iris from the surrounding pixels depicting sclera, eyelid, eyelash, and pupil. The segmented iris image frames 232, 234 can be “unwrapped,” that is, transformed from Cartesian coordinates to polar coordinates as a rectangular block representation of a fixed size. The resulting block iris image frames, referred to as “iris polar images,” can be globally aligned. For example, each iris polar image can be globally shifted to a position that has the smallest hamming distance to the iris polar image generated from the base frame. The globally aligned iris polar images can be each partitioned into a number of local patches. A local patch alignment can be performed using DFT registration in sub-pixel level. The local patches of each RGB iris image frame 232 can be selectively fused using a weighted linear combination with the determined base RGB iris image frame in the polar coordinate system to generate a high quality RGB iris polar image 236. Similarly, the local patches of each NIR iris image frame 234 can be selectively fused using a weighted linear combination with the determined base NIR iris image frame in the polar coordinate system to generate a fused NIR iris polar image 238. This may largely increase the iris feature detail that can be lost during capture of a low resolution image, for example a preview image or front-facing phone camera image. Though depicted as complete images of an eye, in some embodiments, fused RGB iris polar image 236 may include only fused iris data 237 (for example as a polar coordinate block) and the rest of the image 236, if included, may have the same resolution as the determined sharpest RGB iris frame. Similarly fused NIR iris polar image 238 may include only fused iris data 239 (for example as a polar coordinate block), and the rest of the image 238 if included may have the same resolution as the determined sharpest NIR iris frame. In some embodiments, a single image captured by the camera 212 may have sufficient resolution for multispectral iris authentication, and accordingly the iris fusion stage 230 can be omitted.

In some embodiments, the fused RGB iris polar image 236 and the fused NIR iris polar image 238 may be super resolution images. However, super resolution is only one way to generate a high quality image. From multiple low-quality images, super-resolution techniques can be used to generate a high-resolution image by increasing the image resolution, e.g., the number of pixels. Another approach is to maintain the resolution of the image, but increase the detail information through fusion. Accordingly, a fused image has the same number of pixels but with enriched details. As used herein, the terms “high quality” and “low quality” refer to the amount and/or quality of iris feature detail in a single image, for example as indicated by the luminance of the image data representing the amount of light reflected at a given angle off of the textured structures of the iris. For example, a high quality image may be used in iris verification to produce accurate results, e.g. less than a threshold of false positives and/or false negatives. A low quality image may produce inaccurate iris verification results, e.g. above than a threshold of false positives and/or false negatives. As used herein, the term “fused” image refers to an image formed from two or more images in order to increase the amount and/or quality of iris feature detail in the fused image relative to the two or more images. Because the texture and features of the iris can be represented vividly via the luminance of the image data, the multi frame fusion techniques described herein can increase the amount of iris detail depicted by the image luminance. Accordingly, a fused image is generated based on information from at least two images, such information representing texture and features of a user iris and including, for example, luminance information, RGB or NIR color channel information, contrast, detected edges, local spatial patterns, and/or frequency information. The images used to generate a fused image may be low quality images and can be selectively fused to obtain a greater level of detail of the iris texture and features than contained in any of the images alone. For example, two or more low quality images may be fused to form a high quality image. In one example, the greater level of detail in the fused image can be useful for encoded feature matching between the current iris template and a stored iris template. In another example, the greater level of detail can be used to provide more pixels to calculate a liveness detection ratio.

The quality of the iris image, output of the super-resolution, should meet the ISO/IEC DIS 29794-6 standard for better iris identification accuracy in some embodiments. Several example metrics to measure the image quality are edge density, interlacing, illumination and pupil dilation. Blurred images or images that fail to meet the ISO/IEC DIS 29794-6 standard can be excluded during iris image enrollment.

The authentication stage 240 can include operations performed by one or more of liveness detection module 242, iris verification module 244, and authentication module 246. In some embodiments is the results of liveness detection performed by liveness detection module 242 module indicate that the imaged iris is an imitation and not a real human iris, then iris verification module 244 may not perform feature matching between the imaged iris and a stored template iris.

Liveness detection module 242 can receive the fused RGB image 236 and fused NIR image 238 from the multi frame iris fusion module 231 in some embodiments. In other embodiments, if a single image captured by the camera 212 has sufficient resolution for multispectral iris authentication, liveness detection module 242 can receive RGB and NIR image data depicting an eye from the tracking module 221. Liveness detection module 242 can determine adjacent iris and sclera regions in each of the RGB and NIR images, can determine NIR and red channel sensor responses in each of the RGB iris and sclera regions and the NIR iris and sclera regions, and can use the determined sensor responses to calculate a liveness score. The value of the liveness score can be compared to a value or range of values consistent with reflectance properties of a real human eye to determine whether the imaged eye is real or a spoof. Since the sclera and pupil of an actual eye are two separate structures and composed of different tissues, they have different reflectance properties when imaged at various wavelengths of the electromagnetic spectrum. The dense, fibrous, and collagenous structure of the sclera decreases in reflectance as the wavelength of the illumination increases, while the reflectance from the melanin of the iris increases with the same increase in illumination wavelength. Because these properties are known, fake irises can be detected by comparing a ratio of the imaged iris to sclera reflectance values at different wavelengths of the spectrum to an expected ratio value, referred to herein as the “liveness score.” Fake irises which are printed are composed of a single material in both the iris and sclera region and therefore will not exhibit the same liveness score as a live iris. Other spoofs, such as printed iris contacts and prosthetic eyes, which are comprised of two different tissues in the iris and sclera region, can exhibit a liveness score which deviates from the expected liveness score of a real iris and can be detected.

Iris verification module 244 can receive the NIR image 238 from the multi frame iris fusion module 231 in some embodiments. In other embodiments, if a single image captured by the camera 212 has sufficient resolution for multispectral iris authentication, iris verification module 244 can receive NIR image data depicting an eye from the tracking module 221. In some embodiments, the image data captured using an NIR LED may provide for more consistent images of the same iris under a variety of ambient lighting conditions compared to RGB images of the iris, and accordingly the NIR image 238 can be used for feature matching. Prior to feature matching the iris must be located, isolated, and segmented to remove pixels corresponding to the eyelid, eyelashes, and pupil, as well as any areas of specular reflection of light off of the surface of the eye. As discussed above, this can be done by the tracking module 221 or the fusion module 231, or can be performed in other embodiments by a segmentation module included in the iris verification module 244. Iris verification module 244 can include a feature extraction module that converts the segmented iris into a numerical feature set, for example based on Gabor filters for encoding information within the segmented iris image to create a template of the imaged iris. Iris verification module 244 can include a matching module that compares the extracted template against stored templates to give a quantitative assessment of likeness, for example a match score or a binary “match” or “no match” output.

Authentication module 246 can be the decision-making module of the system 200 for determining whether to authenticate the user based on the results from liveness detection module 242 and/or iris verification module 244. The liveness score generated by the liveness detection module 242 can be sent to the authentication module 246 for determining whether the imaged iris is real and to perform iris verification or whether the imaged iris is fake and to not perform iris verification in some embodiments. If the liveness score indicates that the image data depicts a real iris, authentication module 246 can use the match score output by the iris verification module 244 to determine whether to authenticate the identity of the user. In some embodiments the authentication module 246 can compare the match score to a threshold in order to determine whether to authenticate the user. This threshold can vary depending on the application, for example moving closer toward the maximum potential similarity score in systems having a high security objective and moving away from the maximum possible similarity score if the objective of the system 200 is to provide an easy, accessible system. If both the liveness score output by the liveness detection module 242 indicates the imaged iris is a genuine human iris and the quantitative likeness assessment output by the iris verification module 244 indicates that the imaged iris matches a stored template iris, then the authentication module 246 can output an indication 247 of passing authentication. If either the liveness score output by the liveness detection module 242 indicates the imaged iris is an imitation human iris or the quantitative likeness assessment output by the iris verification module 244 indicates that the imaged iris does not match a stored template iris, then the authentication module 246 can output an indication 247 of failing authentication.

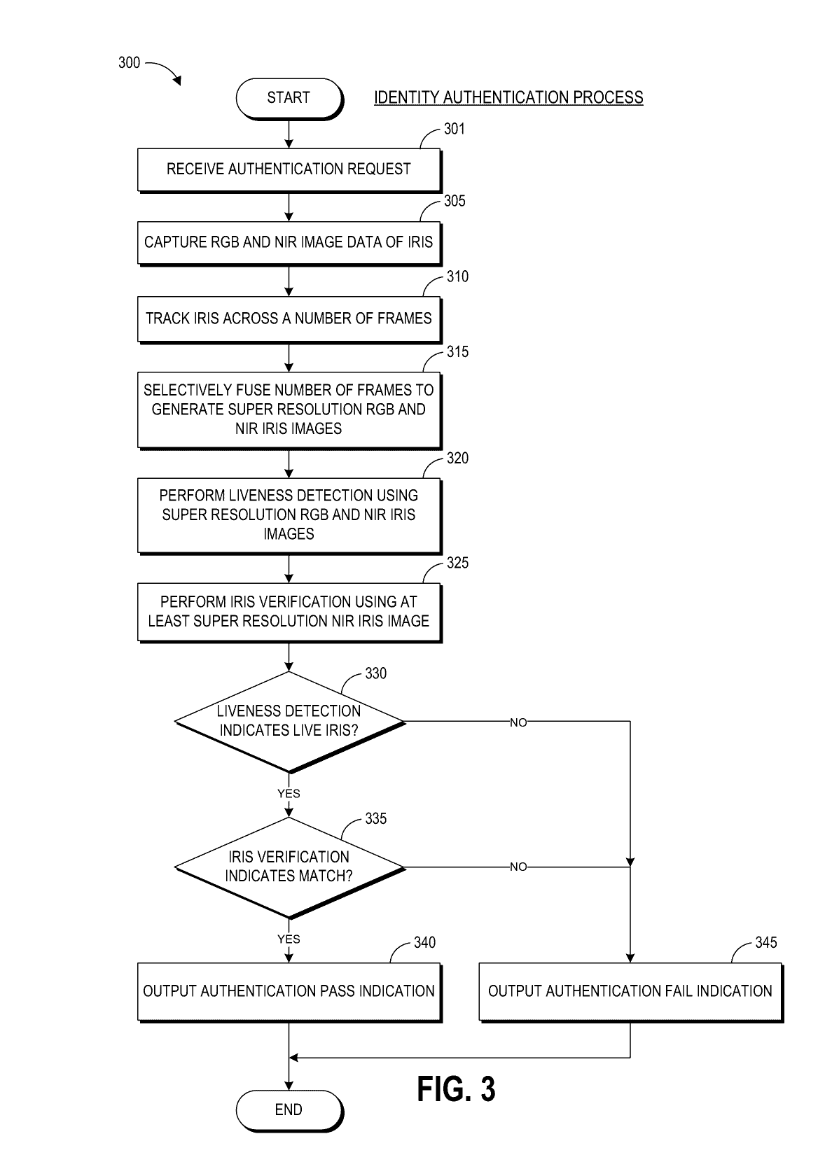

FIG. 3 is a flowchart illustrating an embodiment of an identity authentication process 300 implementing multispectral iris authentication. For purposes of illustration, the process 300 is discussed as being implemented by the components of the multispectral iris authentication system 200, however any system having the multispectral iris authentication capabilities discussed herein can implement the process 300. Further, as will be discussed in more detail below, certain aspects of the illustrated process 300 may be optional in various implementing systems and can accordingly be omitted from embodiments of the process, and certain portions of the illustrated process 300 can be performed independently as a separate process.

At block 301 the multispectral iris authentication system 200 can receive an authentication request to authenticate the identity of a user. For example, the authentication request can be triggered in various embodiments by a user request to unlock a digitally locked mobile device, log in to a secure account, enter a secure location, or the like.

At block 305 the multispectral iris authentication system 200 can configure camera 212 to capture four-channel RGBN (red, green, blue, and near-infrared) image data of the eye of the user in some embodiments. In other embodiments, other channels can be used corresponding to sensor properties, for example other color channels in combination with an IR or NIR channel, or monochrome image data with at least one IR or NIR channel. The unique textures and features of the iris of the user's eye can be used for secure identity authentication. In some embodiments of the process 300, an RGB image and an NIR image can be captured by a single sensor or by an RGB sensor and an NIR sensor. In some embodiments of the process 300, a single RGBN image can be captured. Based at least partly on the sensor resolution and desired level of iris detail in the captured image(s), the camera 212 can be configured to capture a single image or a number of image frames.

At block 310 the tracking module 221 can track the eye and iris location across the number of frames. The eye location can be tracked in order to determine pixels corresponding to the sclera of the imaged eye and the iris location can be tracked in order to determine pixels corresponding to the iris of the imaged eye. In some embodiments, the tracking can generate an approximate location of each of the eye and iris. In some embodiments, the tracking can be used to perform segmentation of the iris from the surrounding sclera, eyelid, eyelashes, and pupil. The tracking module 221 can continue to track the eye and iris location even if the distance and/or angle between the user's eye and the camera 212 changes.

At block 315, the multi-frame iris fusion module 231 can selectively fuse a number of RGB frames into a fused RGB image and can selectively fuse a number of NIR frames into a fused NIR image, in some embodiments. In other embodiments, a number of RGBN frames can be selectively fused to form a fused RGBN image. As discussed above, the multi-frame iris fusion module 231 can select a base frame based on an image quality metric such as sharpness or contrast, segment pixels corresponding to the iris in each frame, unwrap the segmented iris pixels from each frame into a rectangular block iris polar image, globally align the iris polar images, divide each iris polar image into a number of local patches, match the local patches, and selectively fuse the pixels in the matched patches to obtain a greater level of detail of the luminance and therefore features of the iris. The local patches can be fused based on bilinear interpolation techniques in some embodiments. In some embodiments of the system 200 in which the camera 212 has a sensor of sufficient resolution to capture the desired level of iris detail, blocks 310 and 315 can be omitted. In some embodiments, blocks 310 and 315 can be performed independently of some other portions of the process 300, for example during generation of an initial iris template of a user of the system 200 for storage and use in future identity authentication.

At block 320 the liveness detection module 242 can perform liveness detection using fused RGB and NIR image data. As discussed above, the liveness detection module 242 can determine sensor responses in an iris region and an adjacent sclera region in both the red channel and the NIR channel and construct a liveness score indicative of whether the imaged eye is a genuine live eye or a spoof. The liveness score can be compared to an expected value or range of expected values to determine whether the imaged eye is a genuine live eye or a spoof.

At block 325, in some embodiments the iris verification module 244 can use the NIR fused iris image (or an NIR image or data from the NIR channel of a four-channel image) to generate an unwrapped and normalized polar image of the feature pattern in the iris, encode the pattern of iris features to generate a template of the iris, and to perform feature matching between the generated template and a stored template of an authenticated user iris. In other embodiments the iris verification module 244 can receive an unwrapped and normalized NIR iris polar image. As discussed above, due to the consistent output of the NIR flash 216, NIR image data of a user's iris can be more consistent under a variety of lighting conditions than RGB image data, for example making the process 300 more robust for use on a mobile device. For feature matching, the iris verification module 244 can convolve the iris polar image with Gabor filters, and the phase information output from the Gabor filters can be quantized. Phase information, rather than amplitude, can provide significant information regarding iris texture and pattern within the image. Taking only the phase can allow encoding of discriminating information in the iris while discarding redundant information such as illumination, which is represented by the amplitude component. The encoded features of the iris template can be compared to a stored template using Hamming distance in some embodiments to generate a quantitative assessment of likeness. In some embodiments, the liveness detection block 320 and iris verification block 325 can run in parallel.

At decision block 330, the authentication module 246 can determine whether the liveness score generated by liveness detection module 242 indicates a live iris. If the liveness score generated from the captured image data deviates from an expected liveness score value or range of values known to correspond to genuine live eyes then the process 300 can transition to block 345 and authentication module 246 may output an authentication fail indication. Although depicted as being performed after block 325, in some embodiments the decision of block 330 can be made after the liveness detection of block 320. If the imaged iris fails the liveness detection, authentication module 246 may output an authentication fail indication at block 345 without the system 200 performing iris verification at block 325, conserving processing resources and time as well as battery life of a mobile device implementing the system 200. Accordingly, in some embodiments of the process 300, blocks 325 and 335 may be optional.

If the liveness score generated from the captured image data matches the expected liveness score value or range of values known to correspond to genuine live eyes, then the process 300 can transition to block 335. At block 335 the authentication module 246 can determine whether the output of the iris verification module 244 indicates a match between the template generated from the imaged iris and a stored iris template. In some embodiments the iris verification module 244 can use Hamming distance to output a match score representing the level of statistical significance between the current iris template and the stored iris template. Hamming distance is the measurement of the number of bits between two templates which are not the same. Hence match scores based on Hamming distance are dissimilarity score, and the lower the score between two templates, the more likely they are from the same user. Ideally, the Hamming distance between two images of the same iris of the same user would be 0, but due to occlusion and other uncontrollable factors (intra-class variations), even genuine scores can have some dissimilar bits. As discussed above, a threshold of allowable difference between the current template and the stored template can be adjusted based on the objectives of the system 200 as related to security and accessibility, as well as tolerance for false authentication fail determinations and/or false authentication pass determinations. In some embodiments, the threshold can allow the current enrolled iris template and the stored iris template to have a bit shift of plus or minus four bits in both the horizontal and vertical directions.

If the output of the iris verification module 244 indicates a match, then the process 300 can transition to block 340 at which the authentication module 246 outputs an authentication pass indication. The authentication pass indication represents the determination that the imaged eye is a genuine eye as well as the determination that the imaged iris matches a stored template of an approved user iris. The authentication pass indication can be displayed to the user with information regarding the liveness score and feature matching in some embodiments, as depicted in FIG. 1A. The authentication pass indication can be used to permit user access to secure data, locations, accounts, and the like.

If the output of the iris verification module 244 indicates that the imaged iris and the stored template are not a match, then the process 300 can transition to block 345 at which the authentication module 246 outputs an authentication fail indication. The authentication fail indication represents one or both of the determination that the imaged eye is a spoof or the determination that the imaged iris does not match a stored template of an approved user iris. The authentication fail indication can be displayed to the user with information regarding the liveness score and feature matching in some embodiments, as depicted in FIG. 1B. The authentication fail indication can be used to deny user access to secure data, locations, accounts, and the like.

### Overview of Example Image Capture, Tracking, and Fusion Techniques

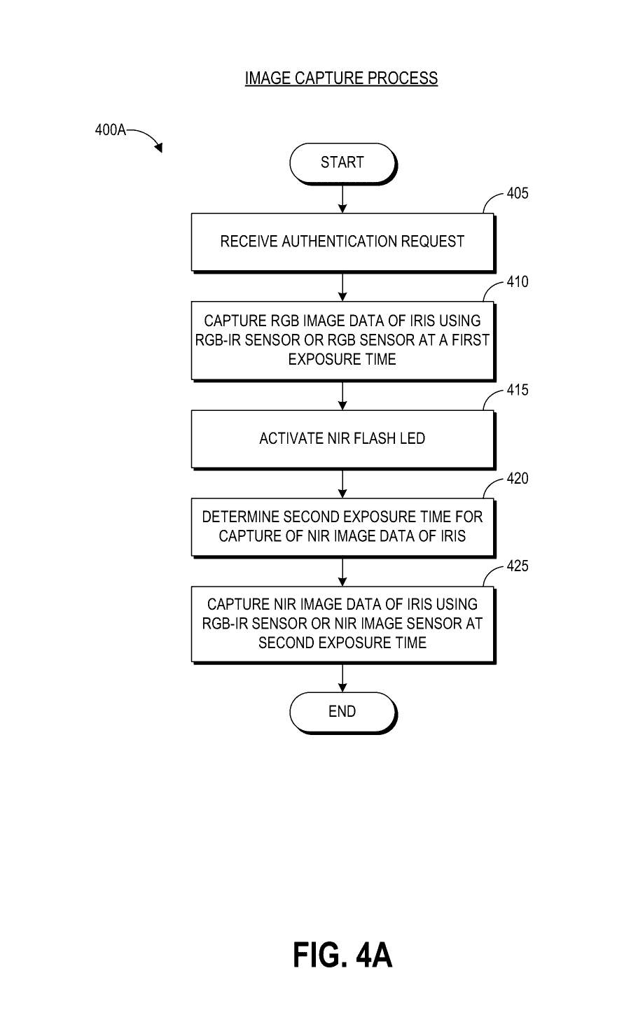

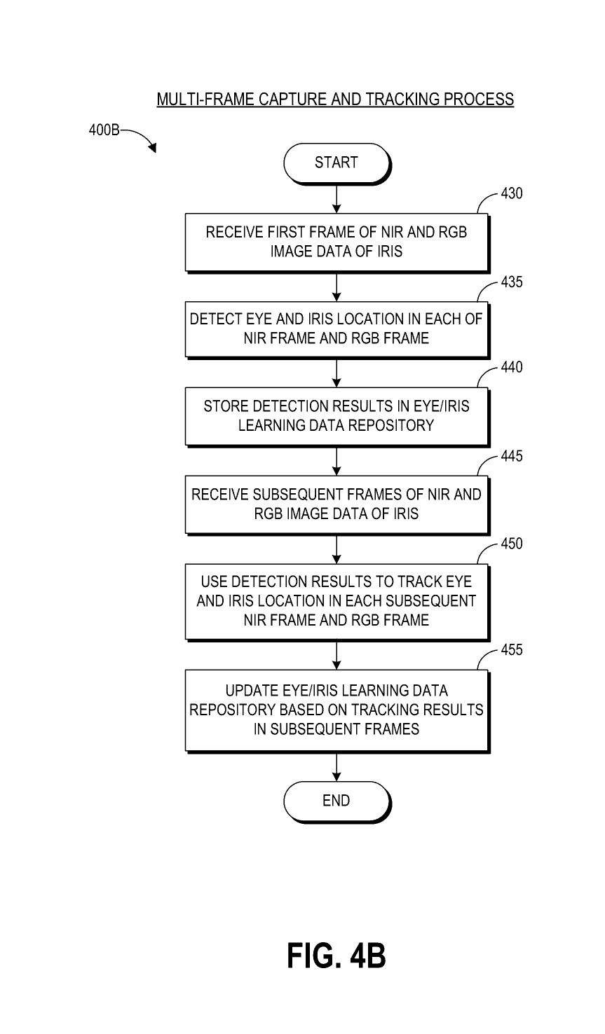

FIG. 4A is a flowchart illustrating an embodiment of a multispectral iris image capture process 400A. The process 400A can be used to capture multispectral image data for use in block 305 of the identity authentication process 300 described above, for generating a template of an authenticated user iris, or for other multispectral iris authentication processes. The process 400A can be implemented by any multispectral image capture device, for example camera 150 and NIR flash 155, camera 212 and NIR flash 216, or any other suitable multispectral image capture system.

At block 405 the multispectral image capture device can receive an authentication request to authenticate the identity of a user in some embodiments. For example, the authentication request can be triggered in various embodiments by a user request to unlock a digitally locked mobile device, log in to a secure account, enter a secure location, or the like. Alternatively, the multispectral image capture device can receive a request to generate multispectral image data of a user iris, for example to generate a template for storage and use in subsequent authentication determinations.

At 410 the multispectral image capture device can capture RGB image data of the user iris at a first exposure time. The RGB image data can be captured using an RGB image sensor or a four-channel RGB-IR sensor in various embodiments. In some embodiments, the first exposure time may be relatively short based on the brightness of ambient illumination.

At block 415 the multispectral image capture device can active an NIR flash LED. Performance of blocks 410 and 415 can begin at substantially the same in some embodiments. The NIR light emitted from the NIR LED is invisible to human eye and therefore unobtrusive, while at the same time providing a controlled and consistent light source. The center of spectral emission of the NIR LED can be approximately 850 nm in some embodiments.

At block 420 the multispectral image capture device can determine a second exposure time for use in capturing NIR image data of the iris. The second exposure time can be determined based on the length of time needed to capture an NIR image of sufficient resolution for use in iris verification, for instance in process 300 described above. In some embodiments, the exposure time for NIR imaging can be pre-determined based on the NIR LED intensity. In some embodiments, the exposure time for NIR imaging can be automatically calculated (or dynamically determined) by an automatic exposure control technique. In some embodiments, block 420 can be performed during image capture to adaptively determine the exposure time for the NIR image data.

At block 425 the multispectral image capture device can capture the NIR image data of the iris at the determined second exposure time. The NIR LED can remain activated for the duration of the second exposure time to illuminate the image scene with NIR light. In some embodiments the NIR image data can be captured using an NIR sensor. In other embodiments the NIR image data can be captured using a four-channel RGB-IR or RGBN sensor; in such embodiments pixel data can be read from red, green, and blue pixels during the first exposure time and pixel data can be read from infrared pixels during the second exposure time. Performance of blocks 410 and 425 can begin at substantially the same in some embodiments, though blocks 410 and 425 can take different amounts of time to complete based on the determined first and second exposure times. Though not illustrated, the process 400A can in some embodiments include processing on the captured RGB and NIR image data such as demosaicking and crosstalk separation.

Although the capture of RGB data and NIR image data are illustrated as occurring in separate blocks (410 and 425) of the process 400, this is one embodiment of a process for capturing multispectral image data. In this example, the multispectral image data can be captured using two separate shots with different exposure settings. In another example, the multispectral image data can be captured using a single shot with different exposure settings for pixels corresponding to RGB and NIR components. In yet another example, the multispectral image data can be captured using a single shot with one exposure setting for pixels corresponding to both RGB and NIR components.

FIG. 4B is a flowchart illustrating an embodiment of a multispectral multi-frame iris image capture and eye tracking process 400B. The process 400B can be implemented by multispectral imaging system 200 at block 310 multispectral iris authentication process 300 in some embodiments, for example by tracking module 221, and the capture of multiple frames using tracking can make the multispectral iris authentication process 300 more robust to hand jitter, head motion, eye blinking, and a user wearing glasses. In some embodiments, camera 212 can be configured in a “preview mode” and/or running at approximately 30-90 fps. The process 400B can be used to capture approximately 20 frames for subsequent fusion in some embodiments.

At block 430 the tracking module 221 can receive a first frame of NIR and RGB image data of an iris, for example the output of the image capture process 400A described above.

At 440 the tracking module 221 can determine eye and iris location in each of the NIR frame and the RGB frame. As described above, for each RGB and NIR frame, the tracking module 221 can determine pixels in each of the captured RGB and NIR images corresponding to a rectangular or other shaped region around the eye and a circular or elliptical region around the iris in some embodiments. Additionally or alternatively, the tracking module 221 can identify pixels along a boundary between the iris and the surrounding sclera, determine an ellipse defined by the identified iris-sclera boundary pixels, determine a distance-to-pixel ratio based on a pixel length of a long axis of such an ellipse compared to a known or presumed diameter of the iris, locate the iris in a three-axis coordinate system, determine an optical axis vector of the eye in the three-axis coordinate system, and calculate a center of the eyeball based on the optical axis vector and a known or presumed eyeball radius. This can be used to determine an approximate distance between the image sensor and the iris.

At block 445 the tracking module 221 can receive subsequent frames of NIR and RGB image data of an iris, for example the output of the image capture process 400A described above. For example, the camera 212 can be configured to capture video of the user's eye at approximately 30-90 fps, and approximately 20 frames can be sent to the tracking module 221 in some embodiments.

At block 450 the tracking module 221 can track the eye and iris location in each subsequent NIR frame and RGB frame. For example, as described above, for each RGB and NIR frame, the tracking module 221 can determine pixels in each of the captured RGB and NIR images corresponding to a rectangular or other shaped region around the eye and a circular or elliptical region around the iris in some embodiments. Additionally or alternatively, the tracking module 221 can determine an approximate distance between the image sensor and the iris.

At block 455 the tracking module 221 can use the tracking results to update an eye/iris learning data repository, for example for enabling more efficient and/or accurate tracking of eye and iris location in subsequent frames.

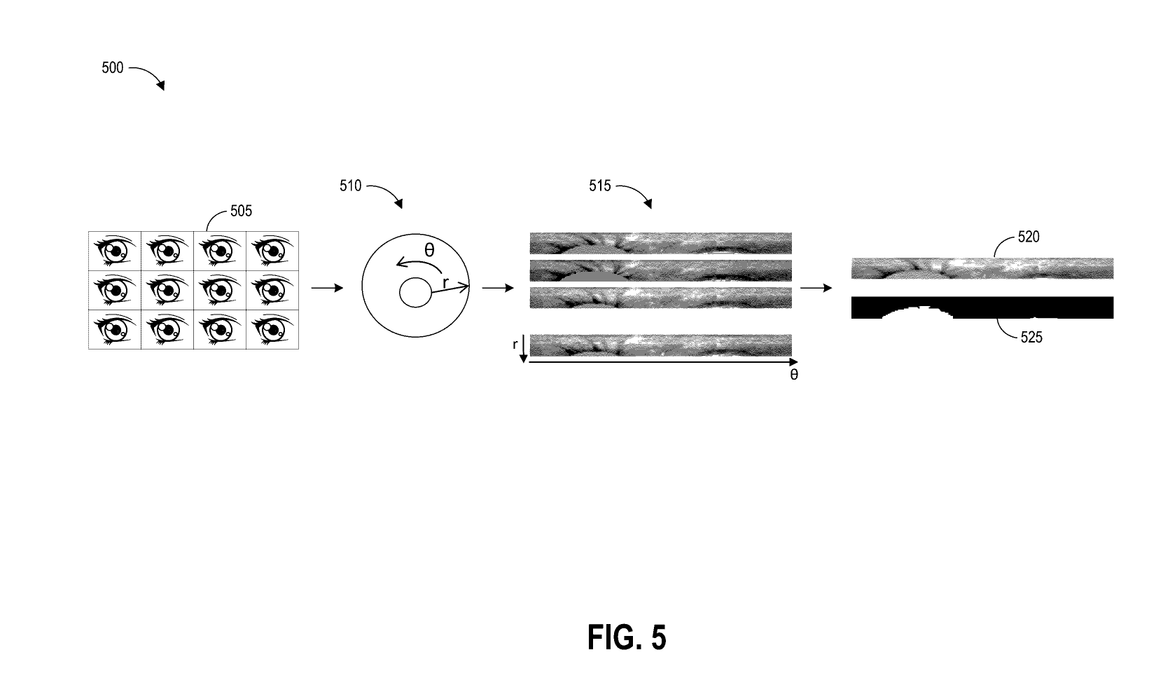

FIG. 5 illustrates a high-level graphical overview of a multi-frame fusion process 500 that can be used to generate a high resolution iris polar image from low resolution iris preview frames, for example an iris image having good luminosity detail representing features of the iris pattern. The process 500 can be implemented by multispectral imaging system 200 at block 315 multispectral iris authentication process 300 in some embodiments, for example by multi frame iris fusion module 231.

A number of iris frames 505 can be provided to the multi frame iris fusion module 231, for example around 20 frames captured in rapid succession such as a rate of 30-90 fps. The iris frames 505 can be preview image frames in some embodiments, for example lower resolution images displayed on a device display or viewfinder as the images are formed on the sensor. Among all the iris frames 505, the multi frame iris fusion module 231 can select one frame as a base frame, for example based on quality measurement metric such as sharpness or contrast.

Though not illustrated, in some embodiments up sampling can optionally be performed on the iris frames 505 depending on frame resolution to increase the size of each of the iris frames 505. Various up sampling methods including nearest neighbor up sampling, bicubic up sampling, step up sampling, or other up sampling methods can be used in various embodiments.

Each of the iris frames 505 can undergo iris segmentation to produce segmented iris image data 510. In some embodiments, the multi frame iris fusion module 231 can find the center of pupil and the center of iris through Hough transform to perform segmentation. Iris segmentation can consist of multiple operations in some embodiments including locating pixels depicting the iris and creation of a mask or masks to remove non-iris components (for example pixels depicting specular reflection, sclera, pupil, eyelash, and eyelid). By eliciting the information across all channels of the multispectral image, a more robust segmentation can be achieved in some embodiments.

Once the image is segmented it can be unwrapped and normalized into a fixed sized polar image. The segmented iris image data 510 of each frame 505 can be mapped to a polar coordinate system (based on r and θ). The multi frame iris fusion module 231 can unwrap the segmented iris image data 510 from the Cartesian coordinates of each frame into a polar coordinates using a block of a fixed size, producing a number of iris polar images 515 based on the image data from the frames 505. The multi frame iris fusion module 231 can normalize the iris polar images 515 to compensate for local deformation due to factors such as pupil dilation and constriction and eye rotation relative to the camera, establishing a unified coordinate system to facilitate subsequent feature matching. The purpose of normalization is to get rid of any inconsistencies caused by the stretching of the iris due to pupil dilation or that arise from eyelid occlusion. In order to exclude the eyelid occlusion region, the multi frame iris fusion module 231 can use a straight line model to approximate the upper eyelid and a geodesic active contour algorithm to exclude the lower eyelid in some embodiments.

The multi frame iris fusion module 231 can perform a global alignment that roughly aligns the iris polar images 515. In some embodiments, global alignment of a 20 pixel by 240 pixel iris template can be performed based on hamming distance. Due to errors in iris localization and normalization as well as variations in the captured details of the iris between the frames 505, precise global alignment may not be possible.

Accordingly, the multi frame iris fusion module 231 can divide each of the iris polar images 515 into different local patches. These patches can be overlapped with the iris polar image generated from the determined base frame, for example local patches having a size of 10 by 40 pixels. In some examples, the multi frame iris fusion module 231 can align the patches using subpixel image registration to align the local patches within a fraction of a pixel, for example using discrete Fourier transform (DFT) or normalized cross-correlation (NCC) image registration techniques in various embodiments. The multi frame iris fusion module 231 can fuse the aligned patches to form fused iris polar image 520. The patches can be fused with the base frame using bilinear interpolation, weighted average, or other image fusion techniques. Mask 525, which can be generated during segmentation of the iris and updated during fusion based on the masks associated with the fused local patches, identifies portions of the current iris polar image that correspond to non-iris noise (sclera, eyelashes, eyelids, etc.). Mask 525 can be used during subsequent feature matching to exclude pixels not representing details of the iris pattern in a template of encoded features generated from the fused polar image from comparison with a stored template.

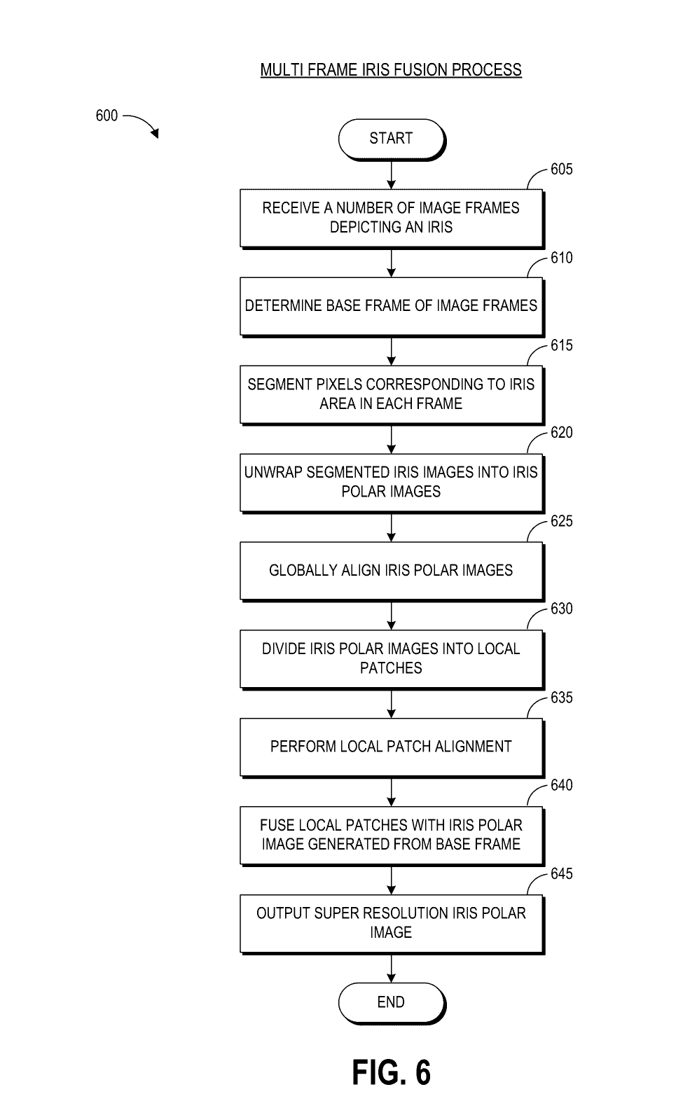

FIG. 6 is a flowchart illustrating an embodiment of a multi-frame fusion process 600 that can be used, similar to process 500, to generate a fused iris polar image from low resolution iris preview frames. The process 600 can be implemented by multispectral imaging system 200 at block 315 multispectral iris authentication process 300 in some embodiments, for example by multi frame iris fusion module 231.

At block 605 the multi frame iris fusion module 231 can receive a number of image frames depicting an iris. In some embodiments, multi frame iris fusion module 231 can receive around twenty RGB, NIR, or RGBN image frames captured in rapid succession such as a rate of 30-90 fps. The frames can be captured by a front-facing camera on a user's mobile device in some embodiments as described above with respect to FIGS. 1A and 1B. The frames may not have sufficient luminosity detail for iris verification in some embodiments.

At block 610 the multi frame iris fusion module 231 can select one of the frames as a base frame, for example based on quality measurement metric such as sharpness or contrast.

At block 615 the image data can be segmented by the multi frame iris fusion module 231. Segmentation involves the removal of information from the capture image data captured which does not pertain to the measurable pattern of the iris. For example, segmentation can involve location of pixels depicting the eyelashes, sclera, eyelid, and pupil of the eye as well as any reflections of light off of the surface of the eye overlying the iris. Segmentation can be used to isolate the pixels depicting the iris and/or to create a mask indicating, for subsequent feature matching, which pixels do or do not correspond to iris features.

At block 620 the multi frame iris fusion module 231 can unwrap the segmented iris image data into rectangular iris polar images of a fixed sixe. To generate the iris polar images, he multi frame iris fusion module 231 can map the segmented iris image data to polar coordinates. For example, the segmented data can be mapped from the Cartesian coordinate system to a polar coordinate system in which a coordinate for each pixel or point of the iris is determined by a distance from a center point (such as the approximate center of the pupil) and an angle from a fixed direction. The multi frame iris fusion module 231 transform the iris representations into a polar coordinate block of a fixed size, producing a number of iris polar images, and can normalize the iris polar images to compensate for local deformation due to factors such as pupil dilation and constriction and eye rotation relative to the camera.

At block 625 the multi frame iris fusion module 231 can globally align the iris polar images, for example based on Hamming distance or keypoint registration in various embodiments. The iris polar image generated from the determined base frame may be used as a primary reference for globally aligning all of the iris polar images.

At block 630 the multi frame iris fusion module 231 can divide each of the iris polar images into a number of local patches, for example pixel blocks such as blocks sized 10 by 40 pixels. In some embodiments, the iris polar image generated from the determined base frame may not be divided into local patches.

At block 635 the multi frame iris fusion module 231 can perform local patch alignment. In some embodiments, patches can be overlapped with the iris polar image generated from the determined base frame. In other embodiments, all iris polar images can be divided into local patches which can be aligned, fused, and stitched together to form a final iris polar image. In some examples, the multi frame iris fusion module 231 can align the patches using subpixel image registration to align the local patches within a fraction of a pixel, for example using discrete Fourier transform (DFT) or normalized cross-correlation (NCC) image registration techniques in various embodiments.

At block 640 the multi frame iris fusion module 231 can fuse the aligned patches to form the fused iris polar image. The patches can be fused with the base frame using bilinear interpolation, weighted average, or other image fusion techniques.

At block 645 the multi frame iris fusion module 231 can output the fused iris polar image, for example for use in generating an encoded template of the features in the fused iris polar image for use in feature matching with a stored iris template or as part of an image of the eye for use in liveness detection.

### Overview of Liveness Detection

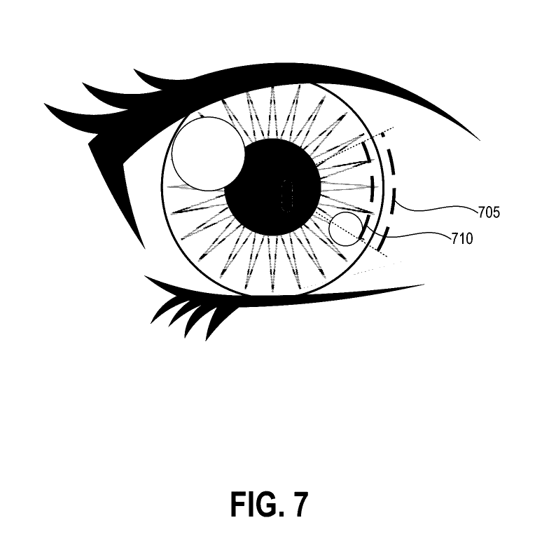

FIG. 7 illustrates a graphical representation of adjacent iris and sclera portions of an eye that can be located for use in liveness detection. As discussed above, the iris is the fibrous, muscular tissue of the eye that contracts and dilates the pupil and includes pigment providing eye color. The sclera, also known as the white of the eye, is the opaque, fibrous, protective, outer layer of the eye containing collagen and elastic fiber.

Iris region 710 and sclera region 705 are neighboring pixel patches located on the iris and sclera, respectively, as shown in FIG. 7. As used herein, neighboring or adjacent refers to location of iris region 710 and sclera region 705 within a threshold distance from one another such that the surface norm of the iris region 710 and the sclera region 705 is approximately equal. Iris region 710 and sclera region 705 can be located based on determining a circle or ellipse of pixels corresponding to the border between the iris and the sclera and selecting neighboring regions on either side of the border in some embodiments. Iris region 710 and sclera region 705 can be used to determine rectangular, circular, or irregularly shaped pixel blocks at which to determine sensor responses indicating the reflectance properties of the imaged materials. The iris region 710 and sclera region 705 are closely located on a smoothly curved surface but they lie on different materials in a genuine human eye. Therefore, iris region 710 and sclera region 705 have similar surface normal, environmental illumination, and sensor direction, but different reflectance properties, and can be used to generate a metric to detect the liveness of the imaged eye. The liveness of the imaged eye refers to an assessment of whether the imaged eye is a genuine live human eye or a spoof such as a printed iris, video of an iris, fake contact lens, or the like.

The camera sensor response R at a given wavelength λ can be determined as an averaged intensity ratio R^{λ} of the pixels patches of the iris region 710 and sclera region 705, as defined by Equation (1) below:

R^{λ}=ρ₁^{λ}/ρ₂^{λ} (1)

where ρ₁^{λ} represents the averaged intensity value of patch i at the wavelength λ. The image intensity value of the surface of the pixel patch can be further defined using Equation (2):

ρ^{λ}=∫_{ω}E(λ)S(λ)Q(λ)dλ (2)

where E(λ) represents the illumination power spectra distribution, Q(λ) denotes the sensor sensitivity, and S(λ) represents the surface reflectance of the material. Because the iris region 710 and sclera region 705 have similar surface normal, environmental illumination, and sensor direction, the intensity ratio R^{λ} can be estimated from the surface reflectance ratio as given in Equation (3).

R^{λ}=ρᵢₙₛ^{λ}/ρ_{sclera}^{λ}≈sᵢᵣᵢₛ^{λ}/s_{sclera}^{λ} (3)

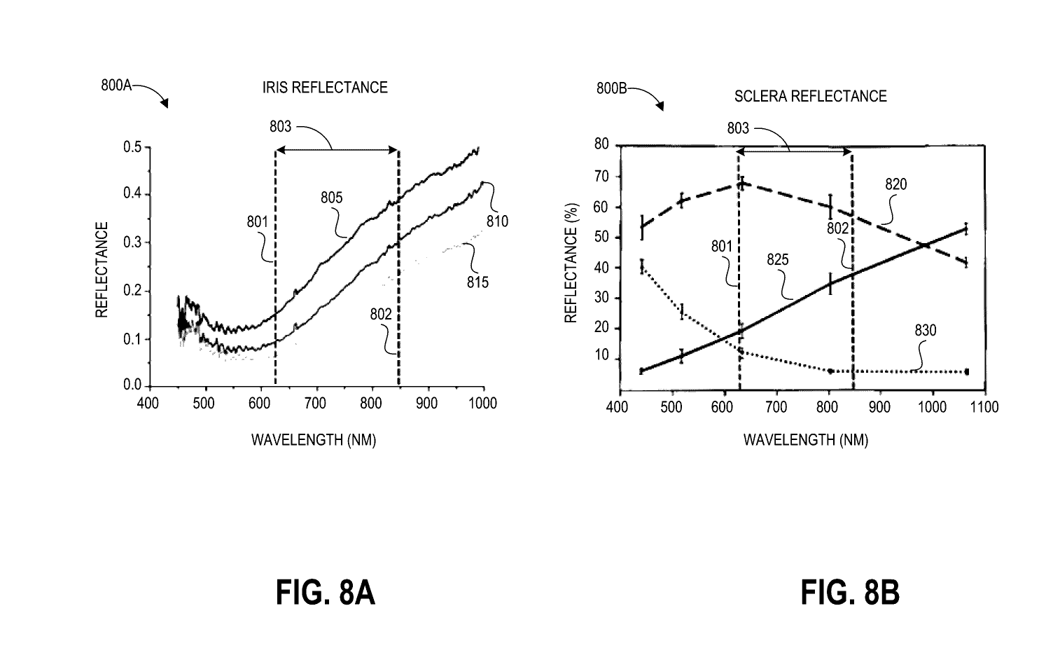

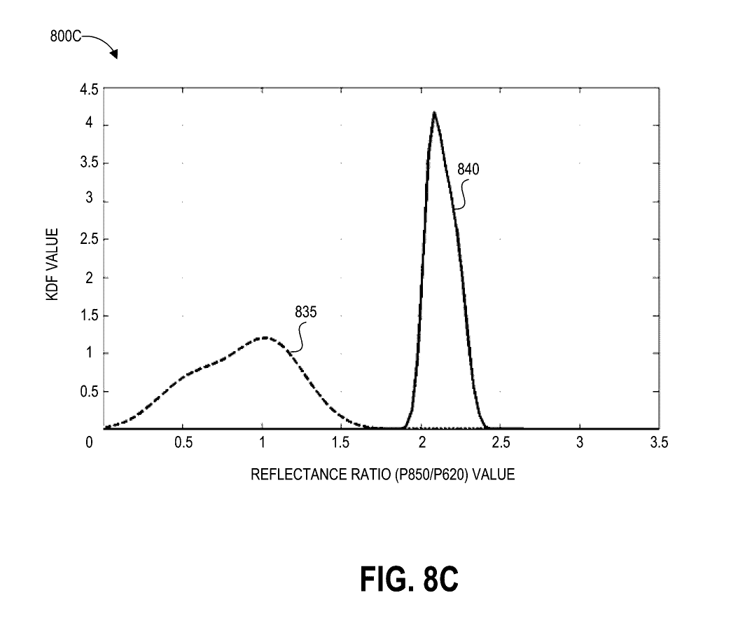

FIG. 8A is a graph 800A illustrating the reflectance spectra of a live human iris at various visible and near-infrared wavelengths. The melanin of the iris generally increases in reflectance as the wavelength of the illumination increases through the spectral range 803 from 620 nm to 850 nm, shown by reference numbers 801 and 802, respectively. As illustrated by the graph 800A, actual reflectance values 805, 810, and 815 of various test samples varied relative to one another but all increased from 620 nm to 850 nm. Accordingly, by using the reflectance value to construct a score for liveness detection rather than analyzing the actual value, liveness detection can be robust to the varying reflectance properties of different iris colors.

FIG. 8B is a graph 800B illustrating the reflectance spectra 820, transmission spectra 825, and absorption spectra 830 of a live human sclera. The opaque, fibrous structure of the sclera decreases in reflectance as the wavelength of the illumination increases through the spectral range 803 from 620 nm to 850 nm, shown by reference numbers 801 and 802, respectively. Because the reflectance of the sclera decreases while the reflectance of the iris increases through the range of same wavelengths, as shown in FIG. 8A, a ratio between iris and sclera reflectance will increase as the spectral wavelengths increase.

FIG. 8C illustrates a statistical ratio histogram distribution of experimental results 800C from using the multispectral iris authentication techniques described herein. The solid lined curve 840 shows the kernel density function (KDF) as a function of liveness score for true human eyes, the liveness score using sensor responses at wavelengths of 850 nm and 620 nm. In some embodiments, wavelengths of 850 nm and 620 nm can be used to generate the liveness score due to those wavelengths representing the boundaries of the range 803 illustrated in FIGS. 8A and 8B, the range in which iris reflectance consistently increases while sclera reflectance consistently decreases. Other embodiments of the liveness score can be generated using sensor responses at any other pair of wavelengths within the range 803 from 620 nm to 850 nm. In one embodiment, the liveness score can be generated using sensor responses at a wavelength in the red channel and a wavelength in the NIR channel due to the red channel typically performing better than the green and blue channels during image capture. However, in other embodiments another channel may outperform the red channel, and then a wavelength in such channel may be used together with a wavelength in the NIR channel to generate the liveness score. As illustrated by FIG. 8A and 8B, iris reflectance continues to increase at wavelengths between 850 nm and 1000 nm, while sclera reflectance continues to decrease at wavelengths between 850 nm and 1000 nm. Accordingly, in some embodiments the pair of wavelengths used to construct the liveness score can be selected from a range of suitable wavelengths from 620 nm to 1000 nm. Although the experimental results described herein were based on a liveness score constructed using sensor responses at wavelengths of 850 nm and 620 nm, mention of these specific wavelengths is for purposes of explanation and is not intended to limit the wavelength pair used to construct the liveness score.

The illustrated curve 840 is based on 76 pairs of RGB and NIR images from a brown iris subject. The dashed line curve 835 shows the KDF as a function of liveness score for spoofs formed as paper printed eyes. The illustrated curve 835 is based on three pairs of RGB and NIR images of the spoofs, the spoofs depicting iris images from two different subjects with different iris color and captured under different illuminations. The experimental results 800C illustrate that a genuine human iris has relatively larger liveness score value compared with liveness score value of fake iris images. For example, for a liveness score calculated using sensor responses at wavelengths of 850 nm and 620 nm, liveness score values between zero and approximately 1.75 consistently indicated that the imaged iris was a spoof, while liveness score values between approximately 1.75 and approximately 2.5 consistently indicated that the imaged iris was a genuine iris.

One embodiment for calculating the liveness score is described below. As described above with respect to Equation (3), the intensity ratio R^{λ} of a pixel patch can be estimated from the surface reflectance ratio. Based on Equation (3), the reflectance ratio (referred to as the liveness score) of the iris to the sclera at the red band and the NIR band can be calculated according to Equation (4),

$${R}^{nir} \text{/} {R}^{red} = \frac{{ρ}_{iris}^{nir}}{{ρ}_{sclera}^{nir}} \text{/} \frac{{ρ}_{iris}^{red}}{{ρ}_{sclera}^{red}} \approx \frac{{s}_{iris}^{nir}}{{s}_{sclera}^{nir}} \text{/} \frac{{s}_{iris}^{red}}{{s}_{sclera}^{red}} = \frac{{s}_{iris}^{nir}}{{s}_{iris}^{red}} \text{/} \frac{{s}_{sclera}^{nir}}{{s}_{sclera}^{red}} \qquad ( 4 )$$

where R^{nir}/R^{red} is determined by the surface reflectance properties of the iris and sclera materials regardless of the environmental illumination across the visible and NIR band. Therefore, based on the graphs 800A, 800B of FIGS. 8A and 8B, for a live human iris, the NIR to red iris reflectance ratio will be greater than one while the NIR to red sclera reflectance ratio will be less than one, as shown in Equation (5).

$$\frac{{s}_{iris}^{nir}}{{s}_{iris}^{red}} > 1 \& \frac{{s}_{sclera}^{nir}}{{s}_{sclera}^{red}} < 1 \qquad ( 5 )$$

From Equations (4) and (5), Equation (6) can be derived for the liveness score.

$${R}^{nir} \text{/} {R}^{red} = \{ \begin{matrix}>> 1 & for a genuine human eye \\ \approx 1 & for a fake iris ( photo printing , plastic eyes )\end{matrix} \qquad ( 6 )$$

As shown by Equations (5) and (6), the liveness score value for a genuine human eye is expected to be greater than 1 because the numerator is greater than one while the denominator is less than one. However, for images of spoofs printed on a single material such as a paper printed iris or a plastic eye, iris pixels and sclera pixels are located on similar materials and therefore the liveness score value should be approximately 1. According to the statistical distribution shown in FIG. 8C, in some examples, for real eyes the liveness score can be centered (mean value) at approximately 2.1, and for fake eyes the ratio can be centered (mean value) at approximately 1.0. A true human iris can be distinguished from a spoof by comparing the liveness score to a threshold.

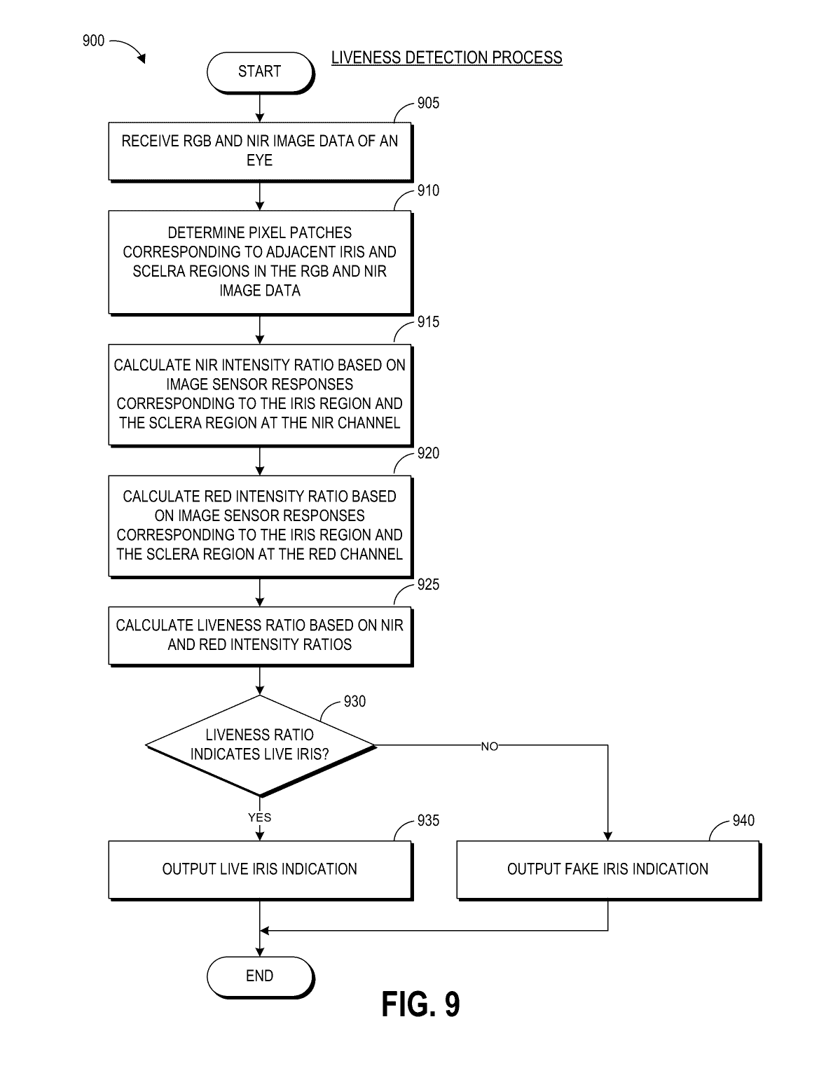

FIG. 9 is a flowchart illustrating an embodiment of a liveness detection process 900. The process 900 can be implemented by multispectral imaging system 200 at block 320 of multispectral iris authentication process 300 in some embodiments, for example by liveness detection module 242.

At block 905 liveness detection module 242 can receive RGB and NIR image data of an imaged eye. The image data can be in the form of a pair of RGB and NIR images or in the form of a single four-channel RGB-IR or RGBN image. In some embodiments, the RGB and NIR image data can include fused RGB and NIR images generated through multi frame iris fusion process 600. In some embodiments, the liveness detection module may only receive image data from two color channels corresponding to the wavelength pair used to generate the liveness score, for example the NIR channel and the red channel. As described above, the wavelengths corresponding to the NIR channel and the wavelengths corresponding to the red channel (or the green or blue channels) can be determined by the structure of the color filter overlying the image sensor used to capture the image data. The NIR channel may correspond to any range of wavelengths between from approximately 750 nm-800 nm to approximately 2500 nm. The red channel may correspond to any range of wavelengths between approximately 570 nm to approximately 760 nm.

At block 910 liveness detection module 242 can determine pixel patches corresponding to adjacent iris and sclera regions in the RGB and NIR image data, for example adjacent regions as shown in FIG. 7. In order for the liveness score as defined by Equation (6) to provide an accurate indication of genuine or spoof irises, the iris pixel patch and the sclera pixel patch need to be adjacent or neighboring such that they have similar surface norm and are similarly illuminated.

In one embodiment, for a pair of RGB and NIR images, the liveness detection module 242 can implement Daugman's algorithm to segment the iris image at the red channel due to the high contrast of iris and sclera by using the following optimization in Equation (7),

$$\vert {max}_{( r , {x}_{0} , {y}_{0} )} \vert {G}_{σ} ( r ) * \frac{\partial }{\partial r} {∮}_{c ( s ; r . {x}_{0} , {y}_{0} )} \frac{I ( x , y )}{2 π r} d s \qquad ( 7 )$$

where r and (x₀,y₀) are candidates for the radius and center of the iris; G_{σ}(r) is the one-dimensional Gaussian smoothing function with standard deviation σ, * is the convolution operator, c(r,x₀,y₀) is the circular closed curve with center with center (x₀,y₀) and radius r, parameterized by s. I is the input eye image at the red channel. After optimization the center and radius of the iris can be obtained, denoted as (x₀,y₀,r)ᵢᵣᵢₛ^{red}. For the NIR image, the liveness detection module 242 can perform a Hough transfer twice in some embodiments to segment the iris and pupil area, denoted by (x₀ ,y₀,r)ᵢᵣᵢₛ^{red} and (x₀,y₀,r)ₚᵤₚᵢₗ^{red}.

The circular intensity integration centered at (x₀,y₀) increases with respect to the increase of the radius from the iris to the sclera. Therefore, liveness detection module 242 can calculate the blurred partial derivative and take the radius with the maximum value as the iris-sclera boundary. To find the radius of a first pixel patch located inside the iris area, for example iris region 710 of FIG. 7, liveness detection module 242 can find the maximum radius such that the blurred partial derivative is below a certain threshold, as expressed in Equation (8) below.

$${r}_{1}^{λ} = max \{ \vert {G}_{σ} ( r ) * \frac{\partial }{\partial r} {∮}_{c ( s ; r . {x}_{0} , {y}_{0} )} \frac{I ( x , y )}{2 π r} d s \vert < T , r < {r}_{iris}^{λ} \} \qquad ( 8 )$$

Similarly, a second pixel patch neighboring the first pixel patch and located inside the sclera area, for example sclera region 705 of FIG. 7, can be found using Equation (9).

$${r}_{2}^{λ} = max \{ \vert {G}_{σ} ( r ) * \frac{\partial }{\partial r} {∮}_{c ( s ; r . {x}_{0} , {y}_{0} )} \frac{I ( x , y )}{2 π r} d s \vert < T , r > {r}_{iris}^{λ} \} \qquad ( 9 )$$

Finally, to exclude the eyelid and eyelash occlusion regions, pixels along the radius of r₁^{λ} angled from −3π/8 to π/8 are clustered into the first patch, and pixels along the radius of r₂^{λ} angled from −3π/8 to π/8 are clustered into the second patch. One example of r₁^{λ} is shown by the dashed border of iris region 710 of FIG. 7, and an example of r₂^{λ} is shown by the dashed border of sclera region 705.

At block 915 liveness detection module 242 can calculate a NIR intensity ratio based on image sensor responses corresponding to the iris region and the sclera region at the NIR channel. The NIR intensity ratio can be calculated based on sensor responses to light at wavelengths of approximately 850 nm in some embodiments. The NIR intensity ratio can be calculated can be calculated according to Equation (10) generated from Equation (4).

$${R}^{nir} = \frac{{ρ}_{iris}^{nir}}{{ρ}_{sclera}^{nir}} \approx \frac{{s}_{iris}^{nir}}{{s}_{sclera}^{nir}} \qquad ( 10 )$$

At block 920 liveness detection module 242 can calculate a red intensity ratio based on image sensor responses corresponding to the iris region and the sclera region at the red channel. The red intensity ratio can be calculated based on sensor responses to light at wavelengths of approximately 620 nm in some embodiments. The red intensity ratio can be calculated can be calculated according to Equation (11) generated from Equation (4).

$${R}^{red} = \frac{{ρ}_{iris}^{red}}{{ρ}_{sclera}^{red}} \approx \frac{{s}_{iris}^{red}}{{s}_{sclera}^{red}} \qquad ( 11 )$$

At block 925 liveness detection module 242 can use the NIR intensity ratio and the red intensity ratio to generate a liveness score, for example according to Equation (4) above.

At block decision block 930, liveness detection module 242 can determine whether the value of liveness score indicates that the imaged iris is a live iris or a spoof. For example, the liveness score value for a genuine human eye is expected to be greater than one because the NIR intensity ratio in the numerator of the liveness score is greater than one, while the red intensity ratio in the denominator of the liveness score is less than one. However, for images of spoofs printed on a single material such as a paper printed iris or a plastic eye, iris pixels and sclera pixels are located on similar materials and therefore the liveness score value should be approximately one. Accordingly, a true human iris can be distinguished from a spoof by comparing the liveness score to a threshold value of one in some embodiments.

If the liveness score indicates that the imaged iris a genuine iris, then the process 900 can transition to block 935. At block 935 liveness detection module 242 can output a live iris indication. The live iris indication can be used by the authentication module 246 to determine to perform iris verification and/or to authenticate the user in some embodiments.

If the liveness score indicates that the imaged iris a spoof, then the process 900 can transition to block 940. At block 940 liveness detection module 242 can output a fake iris indication. The fake iris indication can be used by the authentication module 246 to determine to not perform iris verification and/or to not authenticate the user in some embodiments.

### Overview of Example System

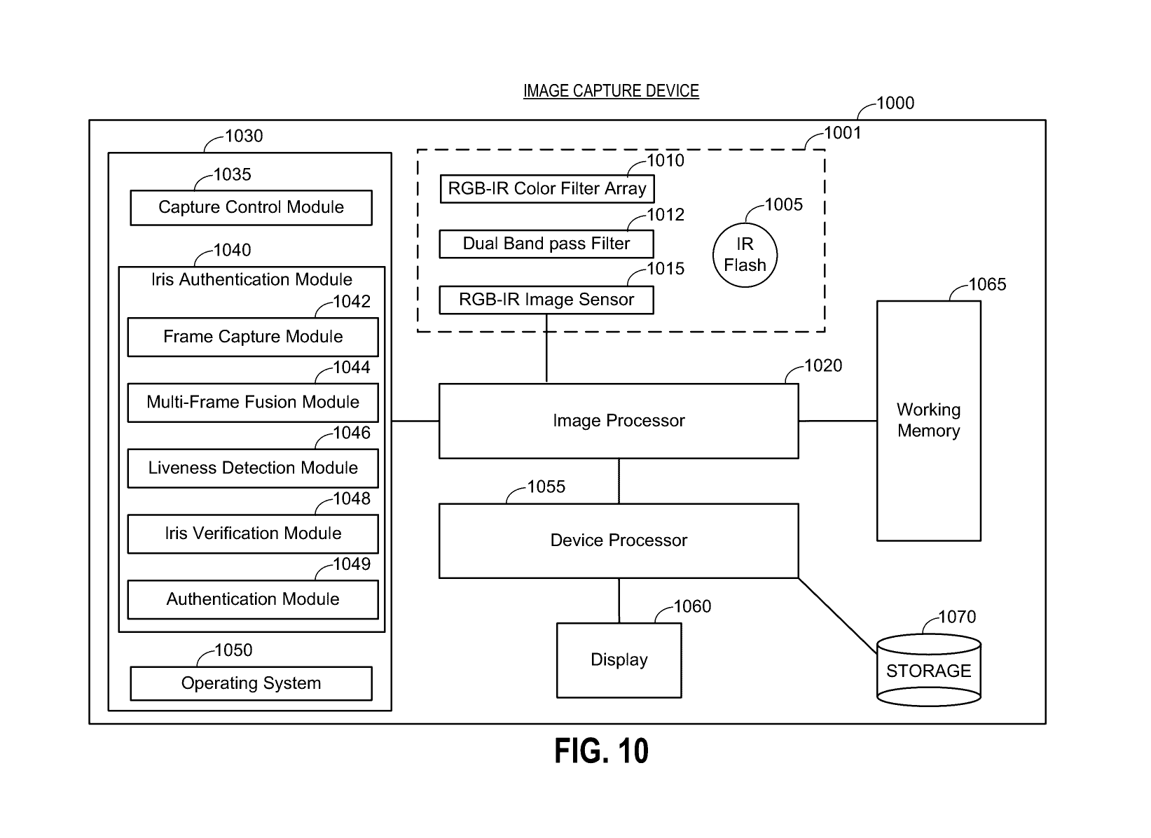

FIG. 10 illustrates a high-level schematic block diagram of an embodiment of an image capture device 1000 having multispectral iris authentication capabilities, the device 1000 having a set of components including an image processor 1020 linked to a camera assembly 1001. The image processor 1020 is also in communication with a working memory 1065, memory 1030, and device processor 1055, which in turn is in communication with storage 1070 and an optional electronic display 1060.

Device 1000 may be a portable personal computing device such as a mobile phone, digital camera, tablet computer, personal digital assistant, or the like. There are many portable computing devices in which using the multispectral iris verification techniques for user authentication as described herein would provide advantages. Device 1000 may also be a stationary computing device or any device in which the multispectral iris verification techniques would be advantageous. A plurality of applications may be available to the user on device 1000. These applications may include traditional photographic and video applications as well as data storage applications, network applications, or other account access applications for which user identity authentication is used.

The image capture device 1000 includes camera assembly 1001 for capturing external images. The camera 1001 can include RGB-IR image sensor 1015, dual band pass filter 1012, RGB-IR color filter array 1010, and IR flash LED 1005 in some embodiments. The RGB-IR (red, green, blue, and infrared) color filter array (CFA) 1010 positioned between the RGB-IR sensor and incoming light from a target image scene can arrange the visible and infrared light on a square grid of photodiodes in the RGB-IR sensor. A dual band pass filter can be positioned between the RGB-IR sensor and the CFA, the dual band pass filter having a first band allowing visible light to pass through the filter and a second band allowing IR light to pass through the filter. The second band can allow passage of a narrow range of IR wavelengths matched to the emission wavelengths of IR flash LED 1005 in some embodiments. Accordingly, a single sensor can be used to capture image data in both visible and IR wavelengths, for example generating an RGB image and an IR image. In some embodiments the assembly 1001 can include an RGBN (red, green, blue, and near-infrared) sensor, RGBN CFA, and NIR flash. It should be appreciated that the order of the dual band pass filter and the CFA can be reversed in some embodiments. In some embodiments, the camera assembly 1001 can use separate RGB and NIR sensors. In other embodiments, the sensor may be configured to capture other channels or channel combinations, for example any color channel or channels (in addition to or instead of the red, green, and blue color channel combination) in combination with an IR or NIR channel, or monochrome image data with at least one IR or NIR channel. In some embodiments, device 1000 can include additional camera assemblies, for example a traditional a (visible light) camera assembly in addition to the camera assembly 1001. The camera assembly 1001 can be coupled to the image processor 1020 to transmit captured images to the image processor 1020.

The image processor 1020 may be configured to perform various processing operations on received multispectral image data in order to execute the multispectral iris verification techniques. Processor 1020 may be a general purpose processing unit or a processor specially designed for imaging applications. Examples of image processing operations include demosaicking, cross talk reduction, cropping, scaling (e.g., to a different resolution), image stitching, image format conversion, color interpolation, color processing, image filtering (e.g., spatial image filtering), lens artifact or defect correction, etc. Processor 1020 may, in some embodiments, comprise a plurality of processors. Processor 1020 may be one or more dedicated image signal processors (ISPs) or a software implementation of a processor.

As shown, the image processor 1020 is connected to a memory 1030 and a working memory 1065. In the illustrated embodiment, the memory 1030 stores capture control module 1035, iris authentication module 1040, and operating system 1050. The iris authentication module 1040 includes sub-modules: frame capture module 1042, multi-frame fusion module 1044, liveness detection module 1046, iris verification module 1048, and authentication module 1049. The modules of the memory 1030 include instructions that configure the image processor 1020 of device processor 1055 to perform various image processing and device management tasks. Working memory 1065 may be used by image processor 1020 to store a working set of processor instructions contained in the modules of memory 1030. Alternatively, working memory 255 may also be used by image processor 1020 to store dynamic data created during the operation of device 200.

As mentioned above, the image processor 1020 is configured by several modules stored in the memories. The capture control module 1035 may include instructions that configure the image processor 1020 to adjust the focus position of camera assembly 1001. Capture control module 1035 may further include instructions that control the overall image capture functions of the device 1000. For example, capture control module 1035 may include instructions that call subroutines to configure the image processor 1020 to capture multispectral image data including one or more frames of a target image scene using the camera assembly 1001. In one embodiment, capture control module 1035 may then call the Radon photography module 240 to reduce the size of the captured plenoptic image data and output the reduced size image data to the imaging processor 220. In another embodiment capture control module 1035 may then call the iris authentication module 1040 to perform any or all of the processes described above relating to multispectral iris authentication.

Iris authentication module 1040 can call sub-modules frame capture module 1042, multi-frame fusion module 1044, liveness detection module 1046, iris verification module 1048, and authentication module 1049 to perform different portions of the multispectral iris authentication data processing and authentication operations. The frame capture module 1042 can include instructions that configure the image processor 1020 to capture one or more image frames including multispectral image information of the target image scene including a user eye. For example, frame capture module 1042 can include instructions that configure the image processor 1020 to capture a number of RGB and NIR frames or a number of RGBN/RGBIR frames at a desired frame rate such as around 30-90 fps, for example using process 400A described above. Frame capture module 1042 can also include instructions that configure the image processor 1020 to track eye and iris location across the number of frames, for example using process 400B described above. In some embodiments, the Radon frame capture module 1042 can transmit the multispectral image data and/or eye and iris tracking information to the multi-frame fusion module 1044.

Multi-frame fusion module 1044 can include instructions that configure the image processor 1020 to selectively fuse image data in the number of frames to generate a fused RGB, NIR, RGB-IR, or RGBN iris image or to generate a fused NIR iris polar image, for example using process 600 described above. Multi-frame fusion module 1044 can transmit fused RGB image data to the liveness detection module 1046 and can transmit fused NIR image data to the liveness detection module 1046 and iris verification module 1048 in some embodiments.

Liveness detection module 1046 can use the received RGB and NIR image data to determine whether the imaged eye is a genuine eye or an imitation eye based on comparison of known iris and sclera reflectance properties at various wavelengths to determined sensor responses at those same wavelengths. For example, using process 900 described above, the liveness detection module 1046 can generate a liveness score according to Equation (4) representing a ratio of NIR channel intensity to red channel intensity in neighboring iris and sclera regions. In some embodiments, liveness detection module 1046 can also compare the liveness score to a threshold and can output a live or spoof indication to authentication module 1049. In other embodiments, liveness detection module 1046 can output the liveness score to the authentication module 1049 for comparison with the threshold.

Verification module 1048 can use received NIR image data to generate a template of the imaged iris for comparison the stored templates. The verification module 1048 can compare the current template and stored templates to generate a quantitative likeness assessment, for example using Hamming distance. In some embodiments, verification module 1048 can compare the generative quantitative likeness to a threshold to determine whether the current template is a match to any stored template and can output a match or no match indication to authentication module 1049. In other embodiments, verification module 1048 can output the quantitative likeness to authentication module 1049 for comparison with the threshold.

Authentication module 1049 can make decisions regarding whether to authenticate the user, that is, grant the user access to the secure data or location, protection for which the multispectral iris verification is being used. Authentication module 1049 can make the decisions based on the input from one or both of the liveness detection module 1046 and iris verification module 1048. For example, in various embodiments the authentication module 1049 can receive data processed simultaneously or nearly simultaneously at the liveness detection module 1046 and iris verification module 1048 and can determine to authenticate the user if both the liveness score indicates a live iris and the template matching indicates a match. If either the liveness score indicates a spoof or the template matching indicates that the imaged iris does not match any stored template, then the authentication module 1049 can determine to not authenticate the user. In some embodiments the authentication module 1049 can receive data processed first from one of the liveness detection module 1046 or iris verification module 1048, and can determine whether further data processing at the other of the liveness detection module 1046 and iris verification module 1048 is needed. For example, if the liveness score is received first and indicates that the captured images depict a genuine iris, then authentication module 1049 can determine that iris verification module 1048 should perform feature matching. However, if the liveness score is received first and indicates that the captured images depict a spoof, then authentication module 1049 can determine that iris verification module 1048 should not perform feature matching. As another example, if the feature matching results are received first and indicate that the captured images depict an iris matching a stored template iris, then authentication module 1049 can determine that liveness detection module 1046 should generate a liveness score using the captured image data. However, if the feature matching results are received first and indicate that the captured images do not depict an iris matching a stored template iris, then authentication module 1049 can determine that liveness detection module 1046 should not generate a liveness score using the captured image data.

Operating system module 1050 configures the image processor 1020 to manage the working memory 1065 and the processing resources of device 1000. For example, operating system module 1050 may include device drivers to manage hardware resources such as the camera assembly 1001. Therefore, in some embodiments, instructions contained in the image processing modules discussed above may not interact with these hardware resources directly, but instead interact through standard subroutines or APIs located in operating system component 1050. Instructions within operating system 1050 may then interact directly with these hardware components. Operating system module 1050 may further configure the image processor 1020 to share information with device processor 1055.

Device processor 1055 may be configured to control the display 1060 to display the captured image, or a preview of the captured image, to a user. The display 1060 may be external to the imaging device 200 or may be part of the imaging device 200. The display 1060 may also be configured to provide a view finder displaying a preview image for a use prior to capturing an image, for example to assist the user in aligning the image sensor field of view with the user's eye, or may be configured to display a captured image stored in memory or recently captured by the user. The display 1060 may comprise an LCD or LED screen, and may implement touch sensitive technologies.

Device processor 1055 may write data to storage module 1070, for example data representing captured images and generated iris templates. While storage module 1070 is represented graphically as a traditional disk device, those with skill in the art would understand that the storage module 1070 may be configured as any storage media device. For example, the storage module 1070 may include a disk drive, such as a floppy disk drive, hard disk drive, optical disk drive or magneto-optical disk drive, or a solid state memory such as a FLASH memory, RAM, ROM, and/or EEPROM. The storage module 1070 can also include multiple memory units, and any one of the memory units may be configured to be within the image capture device 1000, or may be external to the image capture device 1000. For example, the storage module 1070 may include a ROM memory containing system program instructions stored within the image capture device 1000. The storage module 1070 may also include memory cards or high speed memories configured to store captured images which may be removable from the camera. The storage module 1070 can also be external to device 1000, and in one example device 1000 may wirelessly transmit data to the storage module 1070, for example over a network connection.

Although FIG. 10 depicts a device having separate components to include a processor, imaging sensor, and memory, one skilled in the art would recognize that these separate components may be combined in a variety of ways to achieve particular design objectives. For example, in an alternative embodiment, the memory components may be combined with processor components, for example to save cost and/or to improve performance.

Additionally, although FIG. 10 illustrates two memory components, including memory component 1030 comprising several modules and a separate memory 1065 comprising a working memory, one with skill in the art would recognize several embodiments utilizing different memory architectures. For example, a design may utilize ROM or static RAM memory for the storage of processor instructions implementing the modules contained in memory 1030. The processor instructions may be loaded into RAM to facilitate execution by the image processor 1020. For example, working memory 1065 may comprise RAM memory, with instructions loaded into working memory 1065 before execution by the processor 1020.

### Implementing Systems and Terminology

Implementations disclosed herein provide systems, methods and apparatus for multispectral iris authentication and for generation of iris templates for use in iris authentication. One skilled in the art will recognize that these embodiments may be implemented in hardware, software, firmware, or any combination thereof.

In some embodiments, the circuits, processes, and systems discussed above may be utilized in a wireless communication device. The wireless communication device may be a kind of electronic device used to wirelessly communicate with other electronic devices. Examples of wireless communication devices include cellular telephones, smart phones, Personal Digital Assistants (PDAs), e-readers, gaming systems, music players, netbooks, wireless modems, laptop computers, tablet devices, etc.

The wireless communication device may include one or more image sensors, two or more image signal processors, and a memory including instructions or modules for carrying out the multispectral iris authentication processes discussed above. The device may also have data, a processor loading instructions and/or data from memory, one or more communication interfaces, one or more input devices, one or more output devices such as a display device and a power source/interface. The wireless communication device may additionally include a transmitter and a receiver. The transmitter and receiver may be jointly referred to as a transceiver. The transceiver may be coupled to one or more antennas for transmitting and/or receiving wireless signals.

The wireless communication device may wirelessly connect to another electronic device (e.g., base station). A wireless communication device may alternatively be referred to as a mobile device, a mobile station, a subscriber station, a user equipment (UE), a remote station, an access terminal, a mobile terminal, a terminal, a user terminal, a subscriber unit, etc. Examples of wireless communication devices include laptop or desktop computers, cellular phones, smart phones, wireless modems, e-readers, tablet devices, gaming systems, etc. Wireless communication devices may operate in accordance with one or more industry standards such as the 3rd Generation Partnership Project (3GPP). Thus, the general term “wireless communication device” may include wireless communication devices described with varying nomenclatures according to industry standards (e.g., access terminal, user equipment (UE), remote terminal, etc.).

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It should be noted that the terms “couple,” “coupling,” “coupled” or other variations of the word couple as used herein may indicate either an indirect connection or a direct connection. For example, if a first component is “coupled” to a second component, the first component may be either indirectly connected to the second component or directly connected to the second component. As used herein, the term “plurality” denotes two or more. For example, a plurality of components indicates two or more components.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

In the foregoing description, specific details are given to provide a thorough understanding of the examples. However, it will be understood by one of ordinary skill in the art that the examples may be practiced without these specific details. For example, electrical components/devices may be shown in block diagrams in order not to obscure the examples in unnecessary detail. In other instances, such components, other structures and techniques may be shown in detail to further explain the examples.

Headings are included herein for reference and to aid in locating various sections. These headings are not intended to limit the scope of the concepts described with respect thereto. Such concepts may have applicability throughout the entire specification.

It is also noted that the examples may be described as a process, which is depicted as a flowchart, a flow diagram, a finite state diagram, a structure diagram, or a block diagram. Although a flowchart may describe the operations as a sequential process, many of the operations can be performed in parallel, or concurrently, and the process can be repeated. In addition, the order of the operations may be re-arranged. A process is terminated when its operations are completed. A process may correspond to a method, a function, a procedure, a subroutine, a subprogram, etc. When a process corresponds to a software function, its termination corresponds to a return of the function to the calling function or the main function.

The previous description of the disclosed implementations is provided to enable any person skilled in the art to make or use the present invention. Various modifications to these implementations will be readily apparent to those skilled in the art, and the generic principles defined herein may be applied to other implementations without departing from the spirit or scope of the invention. Thus, the present invention is not intended to be limited to the implementations shown herein but is to be accorded the widest scope consistent with the principles and novel features disclosed herein.

What is claimed is:

1. A system for generating a fused iris image, the system comprising:
at least one image sensor configured to capture a plurality of image frames depicting an eye and iris of a user;
a tracking module configured to:
detect a location of the eye and a location of the iris of the eye in an initial frame of the plurality of image frames, and
track one or both of the location of the eye and the location of the iris in at least one subsequent frame of the plurality of image frames; and
a multi-frame iris fusion module configured to:
select a base frame from the plurality of image frames based at least partly on a quality measurement metric,
segment the at least one subsequent frame into a segmented iris by isolating pixels depicting the iris from pixels not depicting the iris,
divide the segmented iris into a plurality of local patches,
align the plurality of local patches with corresponding locations within the base frame, and
selectively fuse at least some of the plurality of local patches with the base frame to generate a fused image including a greater level of detail of the iris than a level of detail of the iris in any of the plurality of image frames.

2. The system claim 1, wherein the at least one image sensor comprises an RGBN image sensor.

3. The system claim 1, wherein the at least one image sensor comprises an RGB image sensor and a NIR image sensor.

4. The system of claim 1, further comprising an iris verification module configured to perform iris verification by comparing a current iris template generated based at least partly on the fused image to a stored iris template.

5. The system of claim 4, further comprising an authentication module configured to authenticate the user based at least partly on a result of the iris verification.

6. The system of claim 4, wherein the fused image comprises NIR image data.

7. A method for generating a fused iris image, the method comprising:
receiving a plurality of image frames depicting an eye and iris of a user;
detecting a location of the eye and a location of the iris of the eye in an initial frame of the plurality of image frames;
tracking one or both of the location of the eye and the location of the iris in at least one subsequent frame of the plurality of image frames;
selecting a base frame from the plurality of image frames based at least partly on a quality measurement metric;
segmenting the at least one subsequent frame into a segmented iris by isolating pixels depicting the iris from pixels not depicting the iris;
dividing the segmented iris into a plurality of local patches;
aligning the plurality of local patches with corresponding locations within the base frame; and
selectively fusing at least some of the plurality of local patches with the base frame to generate a fused image including a greater level of detail of the iris than a level of detail of the iris in any of the plurality of image frames.

8. The method of claim 7, further comprising mapping the segmented iris to polar coordinates.

9. The method of claim 8, further comprising translating the polar coordinates into Cartesian coordinates.

10. The method of claim 9, further comprising using the Cartesian coordinates to generate a rectangular iris template of the isolated pixels depicting the iris.

11. The method of claim 7, further comprising receiving a plurality of RGB image frames depicting the eye and the iris and receiving a plurality of NIR image frames depicting the eye and the iris.

12. The method of claim 11, further comprising generating a fused RGB image based at least partly on the plurality of RGB image frames and generating a fused NIR image based at least partly on the plurality of NIR image frames.

13. The method of claim 7, further comprising receiving a plurality of RGBN image frames depicting the eye and the iris.

14. The method of claim 13, further comprising generating a fused RGBN image based at least partly on the plurality of RGBN image frames.

15. A non-transitory computer-readable medium storing instructions that, when executed, configure at least one processor to perform operations comprising:
receiving a plurality of image frames depicting an eye and iris of a user;
tracking one or both of the location of the eye and the location of the iris in the plurality of image frames;
selecting a base frame from the plurality of image frames based at least partly on a quality measurement metric;
generating a plurality of segmented irises by, for each the plurality of image frames, isolating pixels depicting the iris from pixels not depicting the iris;
dividing a representation of each of the plurality of segmented irises into a plurality of local patches;
aligning the plurality of local patches with corresponding locations within a representation of the base frame; and
selectively fusing at least some of the plurality of local patches with the representation of the base frame to generate a fused image including a greater level of detail of the iris than in any of the plurality of image frames.

16. The non-transitory computer-readable medium of claim 15, the operations further comprising mapping each of the plurality of segmented irises to polar coordinates.

17. The non-transitory computer-readable medium of claim 16, the operations further comprising translating the polar coordinates into Cartesian coordinates.

18. The non-transitory computer-readable medium of claim 17, the operations further comprising using the Cartesian coordinates to generate a plurality of rectangular iris templates each corresponding to one of the plurality of segmented irises.

19. The non-transitory computer-readable medium of claim 18, the operations further comprising globally aligning each of the plurality of rectangular iris templates.

20. The non-transitory computer-readable medium of claim 18, the operations further comprising dividing each of the plurality of rectangular iris templates into the plurality of local patches.

21. The non-transitory computer-readable medium of claim 20, wherein the representation of the base frame comprises one of the plurality of rectangular iris templates generated based at least partly on one of the plurality of segmented irises segmented from the base frame.

22. The non-transitory computer-readable medium of claim 15, the operations further comprising selectively fusing at least some of the plurality of local patches with the representation of the base frame using one of bilinear interpolation or weighted averages.

23. The non-transitory computer-readable medium of claim 15, the operations further comprising aligning the plurality of local patches with corresponding locations within the representation of the base frame using a sub-pixel registration technique.

24. The non-transitory computer-readable medium of claim 23, wherein the sub-pixel registration technique comprises one of DFT registration or NCC registration.

25. The non-transitory computer-readable medium of claim 15, the operations further comprising generating the plurality of segmented irises based at least partly on the location of the eye and the location of the iris as determined by the tracking.

26. A multi-frame iris fusion apparatus comprising:
means for receiving a plurality of image frames depicting an eye and iris of a user;
means for selecting a base frame from the plurality of image frames based at least partly on a quality measurement metric;
means for generating a plurality of segmented irises by, for each the plurality of image frames, isolating pixels depicting the iris from pixels not depicting the iris;
means for dividing a representation of each of the plurality of segmented irises into a plurality of local patches;
means for aligning the plurality of local patches with corresponding locations within a representation of the base frame; and
means for selectively fusing at least some of the plurality of local patches with the representation of the base frame to generate a fused image including a greater level of detail of the iris than in any of the plurality of image frames.

27. The multi-frame iris fusion apparatus of claim 26, further comprising means for capturing the plurality of image frames.

28. The multi-frame iris fusion apparatus of claim 26, further comprising means for tracking one or both of the location of the eye and the location of the iris in the plurality of image frames.

29. The multi-frame iris fusion apparatus of claim 26, further comprising means for using the fused image for iris authentication.

30. The multi-frame iris fusion apparatus of claim 26, further comprising means for providing NIR illumination to the eye and iris of a user.
